(19) United States
(12) Patent Application Publication
(10) Pub. No.: US 2026/0154927 A1
(43) Pub. Date: Jun. 4, 2026

(54) TECHNIQUES FOR LABELING 3D MODELS

(71) Applicant: NeuRealities, Inc., Las Vegas, NV (US)

(72) Inventors: Stephen Lee Curtis, Vancouver, WA (US); Jorge Luis Ortiz, Austin, TX (US); Michael Theodor Hoffman, Stavanger (NO); Michael William House, Hillsboro, OR (US); Alexandra C. Kaiser, Vancouver, WA (US); Christopher Rayner, Seattle, WA (US)

(21) Appl. No.: 19/406,901

(22) Filed: Dec. 2, 2025

Related U.S. Application Data
(60) Provisional application No. 63/727,058, filed on Dec. 2, 2024.

(51) Int. Cl. G06T 19/20; G06T 7/30; G06T 15/00; G06T 17/00; G06V 10/40

(52) U.S. Cl. CPC G06T 19/20; G06T 7/30; G06T 15/00; G06T 17/00; G06V 10/40

(57) ABSTRACT

A method includes: (a) receiving a 2-dimensional line diagram of an apparatus having labels labeling respective sections of the apparatus; (b) aligning a render of a 3-dimensional model of the apparatus to the received 2-dimensional line diagram; (c) establishing a first mapping from labeled sections of the diagram to corresponding regions of the render; (d) determining, for each mapped region of the render, the label from the corresponding section of the apparatus; (e) determining a second mapping from each mapped region of the render to a corresponding section of the model; (f) assigning to each mapped section of the model the determined label from the corresponding mapped region of the render; and (g) displaying the 3-dimensional model to a user and allowing the user to manipulate an orientation of the displayed 3-dimensional model in real-time, including showing the assigned labels in connection with visible mapped sections of the 3-dimensional model.

### CROSS-REFERENCE TO RELATED APPLICATIONS

This application claims the benefit under 35 U.S.C. § 119 (e) of pending U.S. Patent Application Ser. No. 63/727,058, filed Dec. 2, 2024, titled “DOCUMENT PROCESSING AND STANDARDIZATION SERVICE,” which application is hereby incorporated herein by reference in its entirety.

### BACKGROUND

Industries such as manufacturing, energy, travel, automotive, commercial appliances, construction, and facilities management consistently confront challenges in efficiently transferring knowledge. These sectors often face deficiencies in competency related to the operation, maintenance, and repair of intricate physical systems designed for human oversight.

Knowledge transfer within these industries typically occurs through three methods: pre-operational training sessions, real-time task guidance during system operation, and reference materials that provide static instructions. Increasingly, video walkthroughs from experts—shared via internal systems and platforms like YouTube—are becoming popular methods of training and knowledge transfer.

The above-mentioned reference materials and video content often lack contextual awareness, failing to account for the current stage of operation, the system's state, or the operator's physical position in relation to the system.

Augmented Reality (AR) and Virtual Reality (VR) hold the potential to revolutionize training and task guidance in these industries. By harnessing the immersive and interactive features of AR and VR, these sectors could significantly reduce or even eliminate the need for a physical trainer or expert presence. Extended Reality (XR) technologies have been recognized for their effectiveness in addressing these industry challenges by improving retention, reducing training costs, and enhancing scalability.

One process for creating XR applications for training and task guidance is as follows. A training or operations program owner provides requirements for an XR application to an XR product design team. The XR product design team receives the requirements, interviews a Subject Matter Expert (SME) for deeper insights, and reads provided static reference materials to understand the content and context. Once equipped with the requirements and additional insights, the XR Product Design Team then forwards the collated requirements to an XR Product Development Team. The XR Product Development Team takes the requirements from the Design Team and builds the XR application based on the specifications and insights. The SME conducts User Acceptance Testing (UAT) on the newly developed XR application to ensure it aligns with the requirements and functions as expected. The Subject Matter Expert, post-UAT, provides feedback to the XR Product Development Team for any necessary refinements or changes. Finally, the XR application, once developed and refined, can be integrated or used within a Training or Operations Program.

Approaches described in this section have not necessarily been conceived and/or pursued prior to the filing of this application. Accordingly, unless otherwise indicated, approaches described in this section should not be construed as prior art.

### SUMMARY

Despite the recognized benefits, one of the key barriers to the widespread adoption of XR solutions is the prohibitively high cost of content creation. Developing tailored, high-quality XR content requires significant investment of time, money, and specialized expertise, involving complex software programming and the creation of immersive digital content. This high cost limits the scalability and adaptability of XR technologies, preventing them from being a viable solution for the very industries that could benefit most.

The present disclosure addresses these shortcomings by providing a platform that not only leverages the advantages of XR technologies but also significantly reduces the cost and complexity of content creation. By introducing automated content generation tools and intelligent processing systems, the present disclosure enables scalable deployment of XR training programs without the burden of extensive content development costs.

Moving task guidance and training to augmented reality (AR) and virtual reality (VR) platforms offers numerous business benefits:
Reduced Training Costs: Eliminating the need for physical trainers and on-site training facilities can lead to substantial cost savings.
Increased Flexibility: Trainees can access AR and VR training modules at their convenience, allowing for more flexible scheduling.
Improved Retention: The immersive and interactive nature of AR and VR can enhance learning and retention compared to traditional training methods.
Standardized Training: AR and VR platforms can provide a standardized training experience, ensuring consistent quality and content delivery across multiple locations.
Real-time Task Guidance: AR can overlay information and instructions directly onto the physical environment, aiding operators in real-time and reducing the likelihood of errors.
Remote Expert Assistance: AR and VR can connect workers with remote experts who can provide immediate guidance and support, without the need for on-site visits.
Scalability: Once developed, AR and VR training modules can be easily replicated and deployed across different locations, making it easier to scale up training efforts.
Customizable Learning: AR and VR training modules can be tailored to suit the specific needs of individual learners, allowing for a more personalized training experience.
Improved Safety: Training in a virtual environment can reduce the risk of accidents and injuries, particularly in high-risk industries.
Enhanced Performance Metrics: AR and VR platforms can provide real-time analytics and performance metrics, enabling organizations to track and optimize training effectiveness.
Future-proofing: Investing in AR and VR technology can position companies to take advantage of future technological advancements and stay ahead of the competition.

Currently, much of the knowledge in these industries resides in static reference materials such as manuals or in the minds of skilled workers, including valuable but undocumented expertise.

The shift to AR and VR for training and task guidance is hampered by several challenges:
Resource-intensive development: Creating content for these technologies requires a significant investment of time and money, specialized expertise involving complex software programming, and the creation of immersive digital content. One of the key advantages of techniques according to the present disclosure is that the expertise is embedded within the system, reducing the expertise required by those who use it.
Lack of standardization: The absence of standardized AR and VR technologies makes it difficult to implement these systems across different departments or locations.
Inconsistent experiences: Differences in hardware, software, and content quality can lead to inconsistent training experiences, diminishing their potential impact.

As a result, the costs, effort, and lack of standardization associated with AR and VR development and implementation continue to hinder their broader adoption for knowledge transfer in these industries.

Techniques according to the present disclosure may be used to automatically label a 3D model based on a corresponding labeled 2D line diagram of a product to allow a user to manipulate the 3D model and view appropriate labels derived from the 2D line diagram.

In one embodiment, a method performed by a computer system is provided. The method includes: (a) receiving a 2-dimensional line diagram of an apparatus, the line diagram having labels therein labeling respective sections of the apparatus; (b) aligning a render of a 3-dimensional model of the apparatus to the received 2-dimensional line diagram; (c) establishing a first mapping from labeled sections of the 2-dimensional line diagram to corresponding regions of the render; (d) determining, for each mapped region of the render, the label from the corresponding section of the apparatus: (e) determining a second mapping from each mapped region of the render to a corresponding section of the 3-dimensional model: (f) assigning to each mapped section of the 3-dimensional model the determined label from the corresponding mapped region of the render; and (g) displaying the 3-dimensional model to a user and allowing the user to manipulate an orientation of the displayed 3-dimensional model in real-time, wherein displaying includes showing the assigned labels in connection with visible mapped sections of the 3-dimensional model. A computer program product, apparatuses, and system for performing the method are also provided.

### BRIEF DESCRIPTION OF THE DRAWINGS AND APPENDICES

Various aspects of at least one embodiment are discussed below with reference to the accompanying Figures, which are not intended to be drawn to scale. The Figures are included to provide illustration and a further understanding of the various aspects and embodiments, and are incorporated in and constitute a part of this specification, but are not intended to define the limits of the disclosure. In the Figures, each identical or nearly identical component that is illustrated in various Figures is represented by a like numeral. For the purposes of clarity, some components may not be labeled in every figure. In the Figures:

FIG. 1 is a block diagram depicting an example of a system, apparatus, computer program product, and related data structures according to one or more embodiment;

FIG. 2 is a block diagram depicting an example of a system, apparatus, computer program product, and related data structures according to one or more embodiment;

FIG. 3 is a flow diagram depicting an example process according to one or more embodiment;

FIG. 4 is a flow diagram depicting an example process according to one or more embodiment;

FIG. 5 is a flow diagram depicting an example process according to one or more embodiment;

FIG. 6 is a flow diagram depicting an example process according to one or more embodiment.

FIG. 7 is a diagram depicting an example process for accomplishing Human in the middle according to one or more embodiment.

FIGS. 8A-8E are diagrams depicting an example system architecture according to one or more embodiment.

FIGS. 9A-9F are diagrams depicting an example system architecture according to one or more embodiment.

FIGS. 10A-10F are diagrams depicting an example system architecture according to one or more embodiment.

FIG. 11 is a diagram depicting an example process for graph-based RAG according to one or more embodiment.

FIGS. 12A-1 through 12A-6 are block diagrams depicting an example UIF schema according to one or more embodiment.

FIG. 12B is a block diagram depicting an example UIF schema according to one or more embodiment.

FIG. 12C is a block diagram depicting an example UIF schema according to one or more embodiment.

FIGS. 12D-1 through 12D-6 are block diagrams depicting an example UIF schema according to one or more embodiment.

FIGS. 13A-13B are screenshots according to one or more embodiment.

FIG. 14 is a graph illustrating camera positions according to one or more embodiment.

FIGS. 15A-15F are screenshots according to one or more embodiment.

FIG. 16 is a block diagram depicting an example DPS architecture according to one or more embodiment.

FIGS. 17A-17B are screenshots according to one or more embodiment.

FIGS. 18A-18B depict an example labeling process according to one or more embodiment.

FIGS. 19A-19B depict an example labeling process according to one or more embodiment.

FIGS. 20A-20B depict an example labeling process according to one or more embodiment.

FIG. 21 is an example screenshot according to one or more embodiment.

FIGS. 22-23 are example diagrams from an example manual according to one or more embodiment.

Computer Program Listing Appendix A depicts an example UIF schemas code listing. Computer Program Listing Appendix A is hereby incorporated herein by reference in its entirety.

Computer Program Listing Appendix B depicts an example UIF file code listing Computer Program Listing Appendix B is hereby incorporated herein by reference in its entirety.

### DETAILED DESCRIPTION

### 1. Overview

a. Overview of Processes

This Disclosure relates generally to developing and implementing tools and practices that enable the efficient transfer of skills and knowledge, currently contained in static reference materials and held by subject matter experts, to augmented reality (AR), virtual reality (VR), and extended Reality (XR) platforms with minimal human intervention. This may be accomplished by leveraging a document processing service (DPS) and Uniform Instruction Format (UIF) Software Development Kit (SDK) based off existing documentation.

In one embodiment, a training or operations program owner provides documents and specifications of a product to the DPS. The DPS receives and processes the documents provided by the Training or Operations Program Owner. This processing includes performing logical entity extraction, and, in some embodiments, also logical relationship extraction. The DPS then exports this processed data including the extracted logical entities (and logical relationships) into a structured format, such as UIF. Meanwhile, an XR Product Development Team is able to build a UIF-compatible XR application utilizing a special UIF SDK. This developed application is designed to load and interpret the UIF file. Once built, the XR application runs on typical XR hardware such as, for example, VR headsets and mobile devices, loading and interpreting the UIF file to present an AR.VR/XR experience to the user based on the product and its use. A subject matter expert (SME) is able to validate the XR application to ensure it is in line with the requirements, providing feedback for refining and enhancing the XR application.

In the event that the provided documents and specifications do not include a reference manual, the DPS may further create a static reference manual based either directly on the extracted entities and relationships or indirectly on the UIF file.

Once UIF is adopted as the source of truth for documenting systems and processes, another embodiment may be used. An SME captures his or her expertise and knowledge. This can occur through a user interface designed for structured knowledge creation, guiding the expert to capture information in a clear and organized way. Alternatively, videos of processes can be captured and translated into the UIF format. The knowledge can also be generated during the actual product design process by integrating with product design files and formats through systems like Product Data Management (PDM) or Product Lifecycle Management (PLM). Additionally, the UIF can be created by observing ongoing operations, with the system updating the knowledge base based on real-time observations of processes and events. The expert's knowledge is documented using an Instruction Documentation Application (IDA), and the information is saved as a UIF package (or UIF file). The UIF file serves two primary purposes: (1) it is read by a Manual Export Service which then outputs the knowledge into a tangible Operating Manual and (2) it is also loaded into a UIF Compatible XR Application, as discussed above.

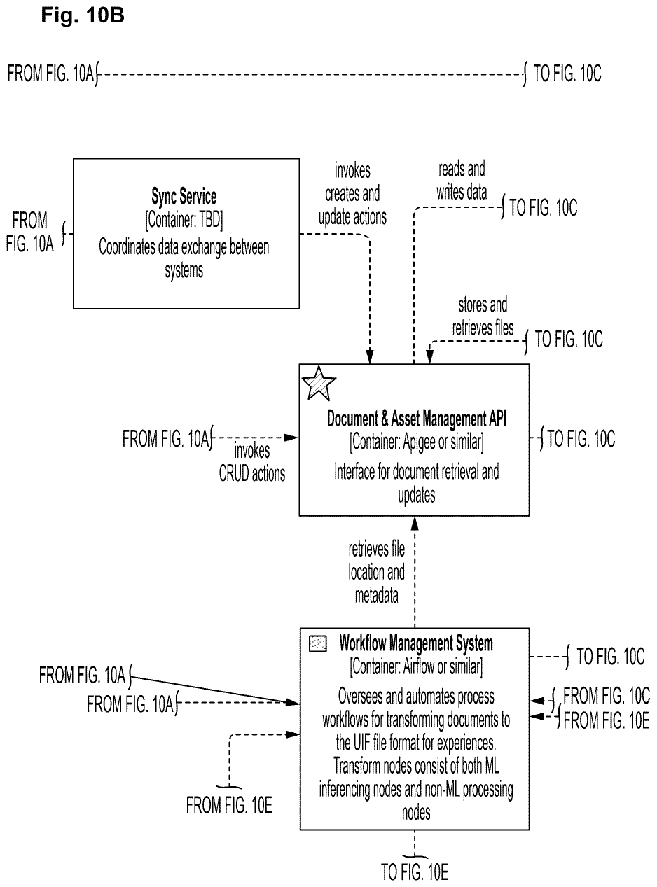

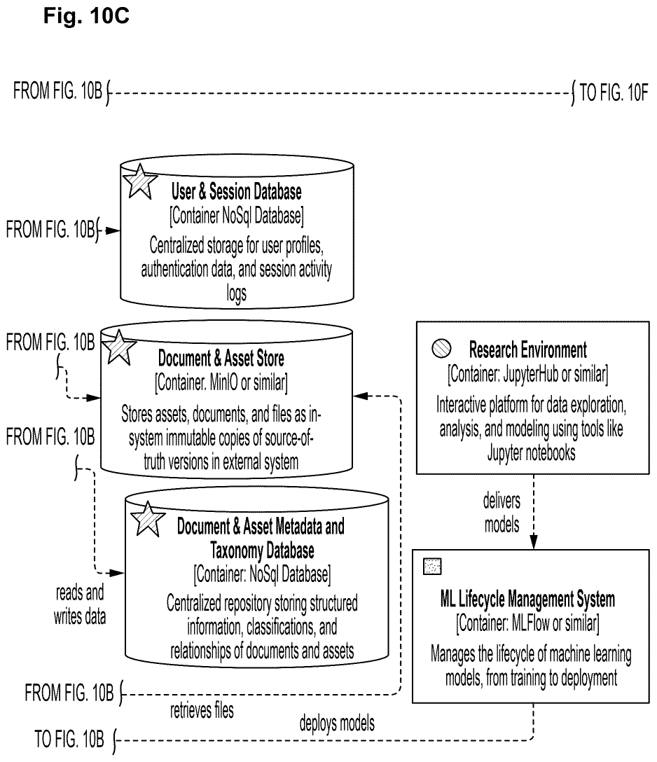

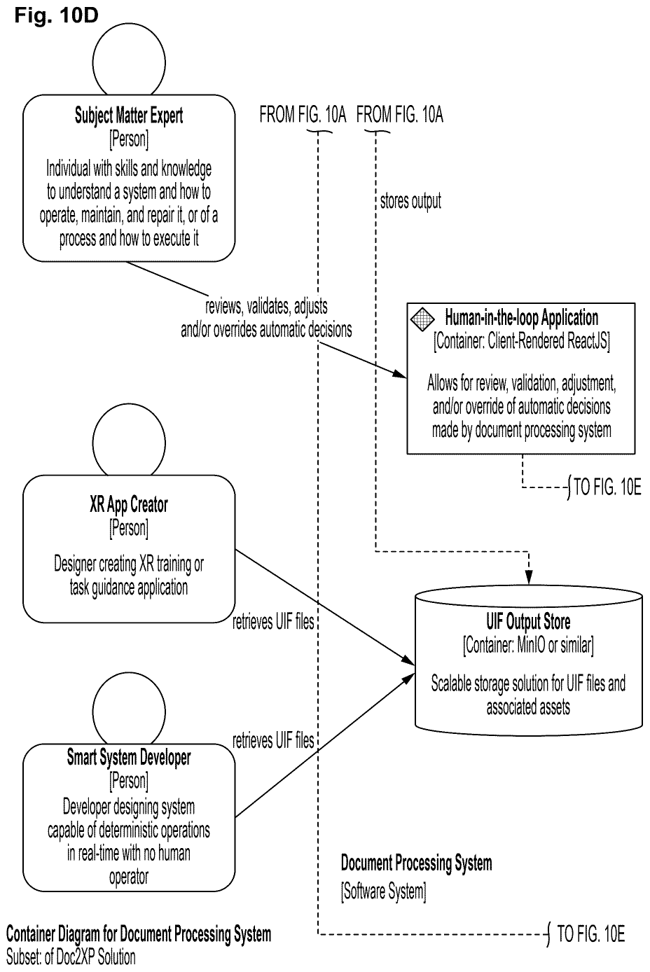

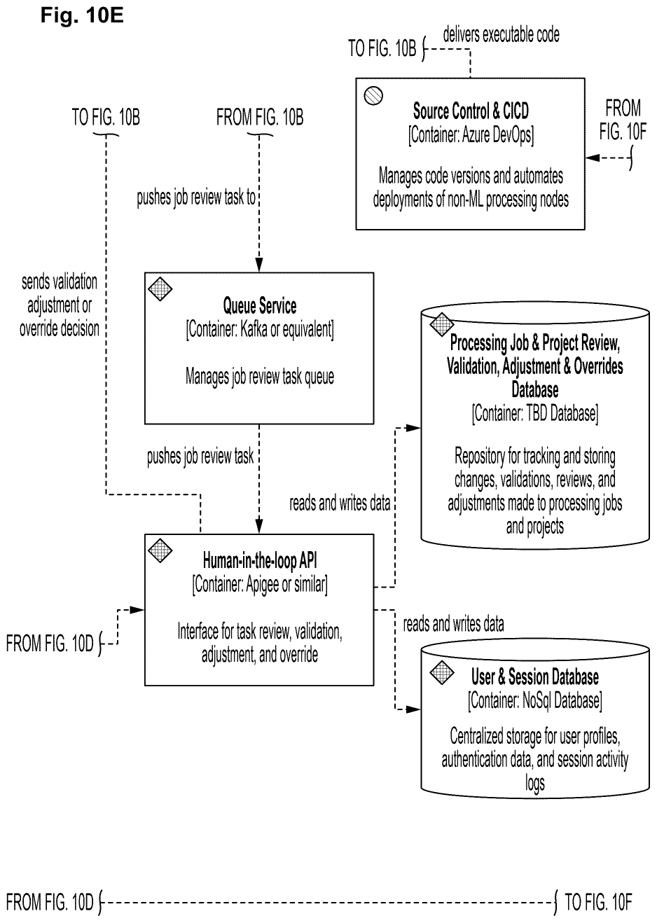

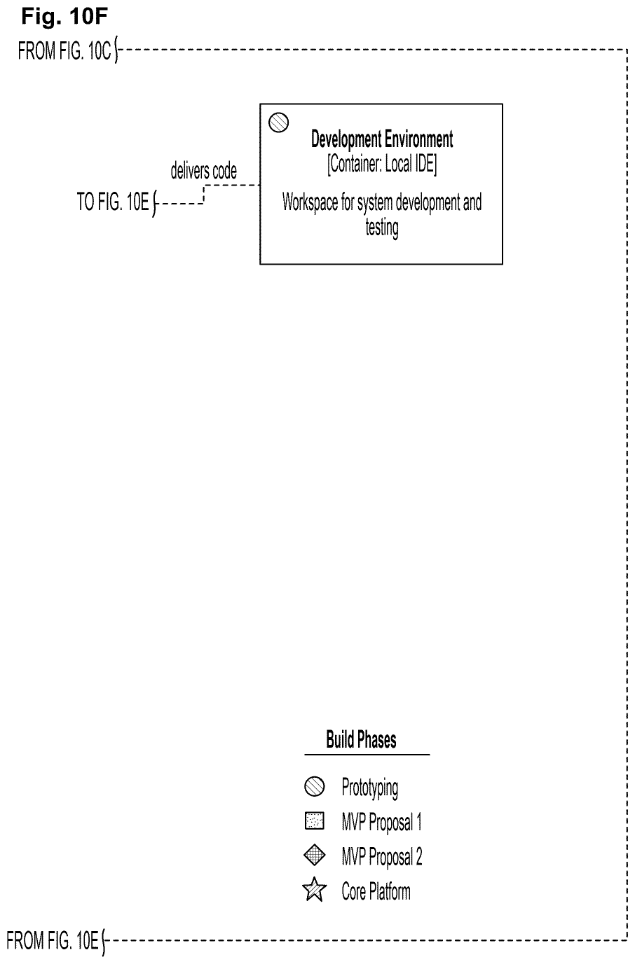

FIGS. 10A-10F represent an example system architecture according to one or more embodiment.

### B. Personas

Subject Matter Expert (SME): An individual with in-depth knowledge and expertise in a particular domain or topic, often consulted during the creation or validation of content, training materials, or XR experiences related to their field of expertise.

Training Program Owner: An individual or group within an organization responsible for overseeing and managing a specific training program that utilizes XR solutions.

Operations Program Manager: An individual or group within an organization responsible for overseeing and managing a specific operational program that utilizes XR solutions or smart systems.

Product or Process Designer: Individual or team that designs a system or process, and provides the initial view on how to operate and maintain a system or execute a process.

XR App Creator: Designer or developer creating XR training or task guidance application.

Smart System Developer: An individual or team responsible for designing and developing automated systems that perform deterministic operations in real-time without requiring human intervention. These systems operate autonomously, executing tasks based on predefined rules and algorithms.

Operations Manager: Individual responsible for the continued operations of a facility, complex physical system or set of processes.

Human Operator: Individual operator of a system or executor of a process.

### C. Example Stakeholders

XR Solutions Company: A company that specializes in providing extended reality (XR) services, technologies, or platforms, encompassing virtual reality (VR), augmented reality (AR), and mixed reality (MR).

XR Product Design Team: A group of professionals dedicated to conceptualizing, designing, and defining the user experience for XR products, ensuring they are intuitive, engaging, and fit for their intended purpose.

XR Product Development Team: A team responsible for the actual building, programming, and technical creation of XR products based on the designs and specifications provided by the XR product design team.

End Customer Corporate Entity: The primary organization or business entity that purchases or licenses an XR product or solution for its use within the organization. Example: an airline in the context of aircraft repair and maintenance training.

End Customer Operations Facility: A specific location or site where the end customer corporate entity deploys and uses the XR solution, such as a manufacturing plant, training center, or office. Example: a manufacturing facility which manufactures aluminum castings.

Physical System Manufacturing Company: A company that produces tangible systems or machinery, which might be operated or maintained with the assistance of XR solutions. Process Design Organization or Company: A company that originates or defines a human-centric process or practice that isn't tied to a physical system.

### D. Concepts

Trusted Source of Truth: A broad category that includes both static and dynamic materials used to convey information, guidance, or instructions. These can include traditional printed manuals, PDFs, videos documenting training processes, and even data or files originating from product development systems. A trusted source of truth also encompasses the logical relationships and functions of a product as defined in other software systems, such as Product Data Management (PDM) or Product Lifecycle Management (PLM) systems. This open-ended definition ensures that future technologies or methods that similarly serve to document or relay knowledge are included.

Operations Manual: A comprehensive guide that provides detailed instructions on how to operate, maintain, or troubleshoot a particular system or equipment.

Spatial Models: A broad term that refers to any digital representation of a physical object, system, or environment. This includes CAD models, which are created using Computer-Aided Design (CAD) software, as well as digital twins, which are dynamic, virtual replicas of real-world objects or systems that can mirror real-time states, conditions, and operations. In the future, spatial models could be represented by technologies not yet developed, which may offer more advanced or immersive representations of physical objects, environments, or systems, possibly integrating AI, sensory feedback, or other innovations to more accurately model and interact with the physical world.

XR Application: A software application developed for extended reality platforms, providing interactive experiences using virtual, augmented, or mixed reality technologies.

AI Assistant: A digital assistant powered by artificial intelligence, designed to assist users by providing information, answering queries, or guiding them through tasks, often leveraging natural language processing and machine learning.

Autonomous Operator: A system or machine capable of performing tasks, operations, or activities without direct human intervention, often relying on AI or robotics.

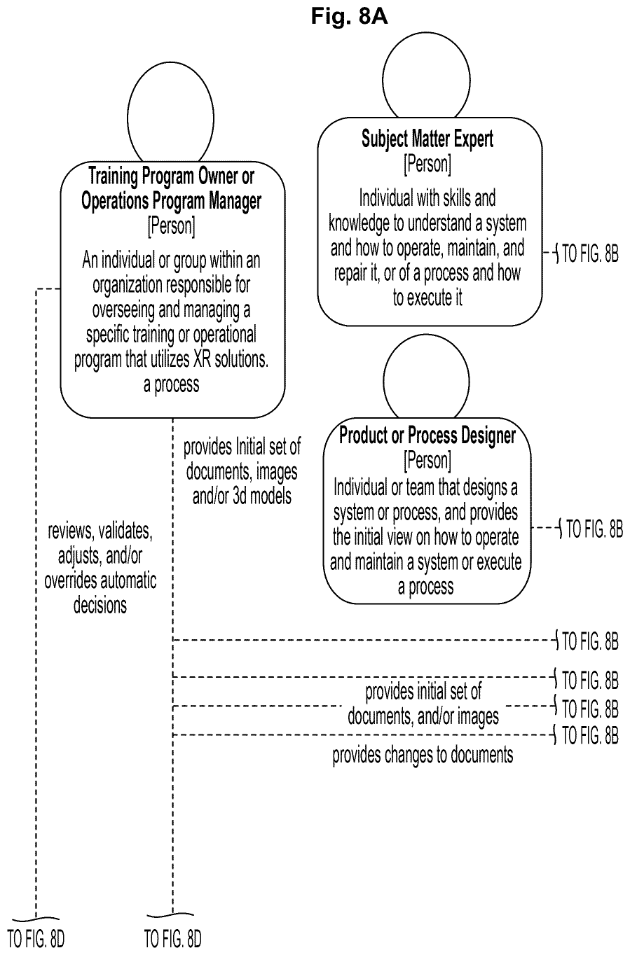

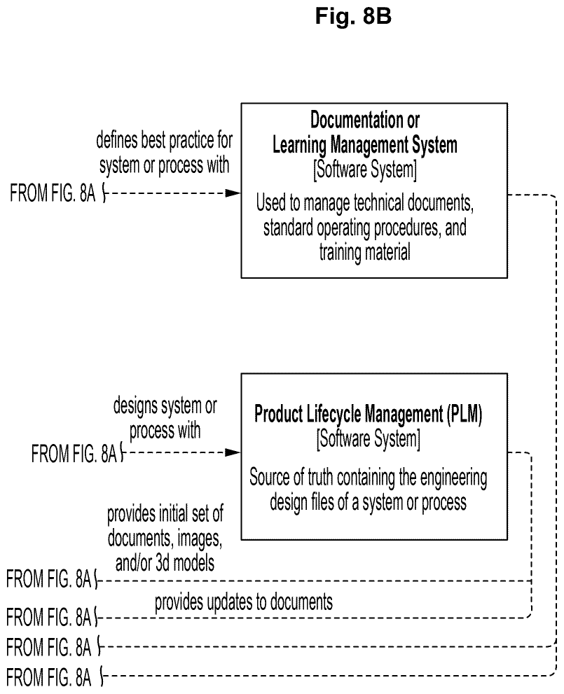

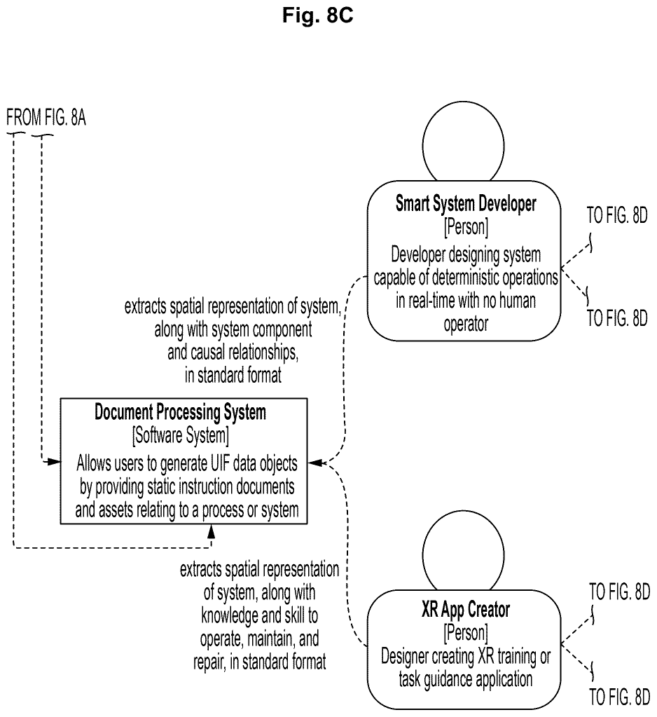

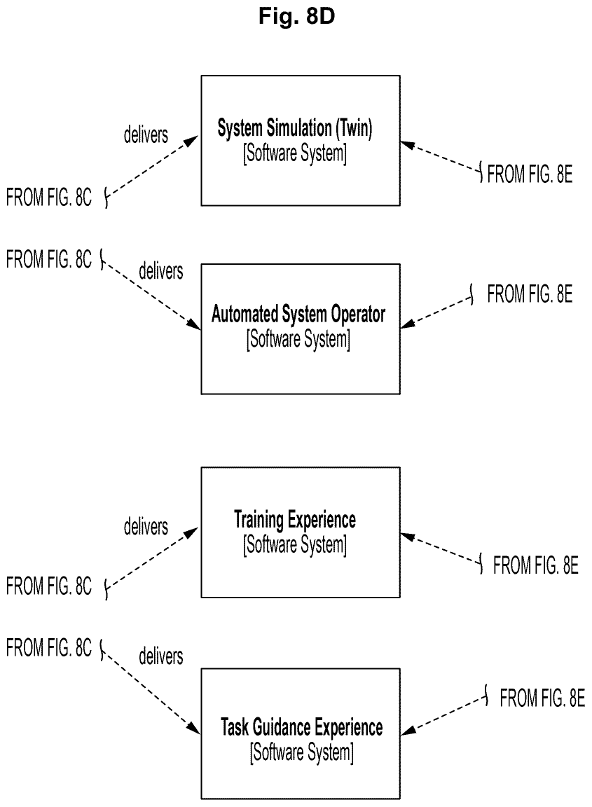

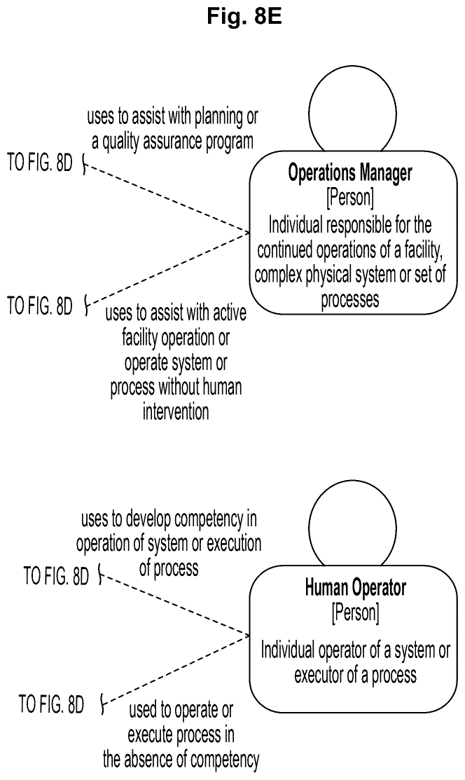

FIGS. 8A-E depict an architecture of an example system, illustrating the relationship between various personas and stakeholders in the larger system context.

### E. Summary of UIF Model

The Universal Instruction Format (UIF) is a flexible data framework designed to convert instructions from static formats, such as Standard Operating Procedures (SOPs) and manuals, into dynamic, interactive formats compatible with augmented reality (AR), virtual reality (VR), digital twins, and autonomous systems. UIF is structured to be both human-readable and machine-readable, facilitating seamless integration across various platforms and technologies.

In addition to its current capabilities, UIF supports the embedding of machine learning (ML) and artificial intelligence (AI) models. These models can encapsulate complex relationships, processes, and linguistic features, enabling the system to handle scenarios where multi-dimensional or dynamic task representations are necessary. By embedding AI models such as neural networks, decision trees, and reinforcement learning algorithms-UIF can represent processes more effectively through probabilistic models, predictive analytics, and other advanced AI techniques. For example, as natural language processing evolves, UIF can seamlessly integrate more advanced conversational interfaces, allowing users to interact with instructional content through voice commands.

The UIF framework is designed with future adaptability in mind. As AI and ML technologies advance, they may take over more of the traditional human-driven steps in the “source of truth→instructional definition→instructional guidance” pipeline. For instance, future systems may rely on AI models that directly generate process instructions, eliminating the need for some intermediate manual steps. In a manufacturing setting, UIF can utilize reinforcement learning algorithms to optimize assembly line instructions dynamically based on real-time performance data.

Although UIF is one solution for managing this process, the framework is designed to accommodate future advancements, ensuring that the system can evolve alongside AI-driven task generation and dynamic process management. This ensures that the UIF package remains extensible and robust, capable of supporting evolving knowledge representation technologies as they emerge. This extensibility is achieved through a modular architecture that allows for the seamless addition of new modules and integrations as technologies evolve.

### F. Process-System Completeness in Data Structures and File Formats

Process-System Completeness is an aspirational concept for data structures and file formats, analogous to Turing Completeness in computing. It stipulates that a data structure is ‘Process-System Complete’ if it contains all necessary data to encapsulate the full complexity of a system's process. This goes beyond static data inclusion, aiming for a dynamic and responsive format that fully represents an environment, process, or system, while enabling SDKs to perform specific actions based on the available data.

Digital Twin Definition: A digital twin is a dynamic, real-time digital representation of a physical system, environment, or process. It continuously mirrors the physical counterpart, collecting data and providing insights to optimize performance or make predictions, such as in predictive maintenance. A process-system complete data model and SDK, in many cases, will effectively create and maintain a virtual or real-time digital twin to facilitate interaction between the human user and the XR task guidance, training, autonomous operation, or AI assistance.

However, the primary purpose of systems built on top of a process system complete data model and SDK isn't just to function as a digital twin. The creation of a virtual or real-time digital twin is a means to an end—the end being to enhance training, enable real-time task guidance, provide autonomous operation, or support AI-driven assistance. The digital twin's role is a tool for achieving these goals, ensuring that all interactions within the system are responsive, adaptive, and effective for the intended tasks.

### Minimum Characteristics of a Process-System Complete Data Structure:

1. Spatial Awareness: The structure is fully aware of the spatial dimensions, positioning, orientations, and interrelationships of entities within a system. This data allows an SDK to dynamically visualize and adjust spatial relationships during operations, particularly for XR-based guidance systems.
2. Temporal Awareness: It has an innate sense of timing, accurately logging sequences, events, durations, and the chronological order of occurrences. This enables an SDK to sequence and control actions within the system, ensuring proper temporal alignment, such as synchronizing maintenance schedules or procedures.
3. System State Recognition: It is sensitive to the system's state at any given time, recognizing both passive and active states. While the data model stores these states, it should enable an SDK to perform actions, such as switching between different operational modes or providing real-time feedback to operators without noticeable delay.
4. Deterministic and Causal Relationship Understanding: The structure maps out cause-and-effect relationships, predicting the impact of changes within one part of the system on others. An SDK should be able to use this information to adjust real-time operations based on these relationships, ensuring system stability and accuracy, particularly in closed-loop systems where real-time adjustments are required.
5. Telemetry Integration: The data model should support telemetry data enabling an SDK to interpret and react to it in real time. The SDK may use telemetry data to adjust system parameters, issue alerts, or trigger specific actions, such as notifying operators of potential failures in predictive maintenance systems.
6. Root Cause Analysis and Learning: The feedback data supported by the data model should allow an SDK to conduct root cause analysis and make adjustments, while the model itself stores the relevant information. This functionality ensures that the SDK can continuously optimize operations based on historical data, identifying patterns in system performance and adjusting future operations accordingly.
7. Real-time Context Awareness: Data should be sufficient such that an SDK that uses the context data from the model can adjust outputs based on real-time situational information, such as adjusting visualizations or executing instructions that match the current operational environment. This could include adapting training modules or operational guidance based on real-world variables.
8. Machine Learning Models and Explainability: The data model embeds AI/ML models including neural networks, decision trees, and reinforcement learning algorithms, which enable the system to interpret and respond to complex instructional scenarios dynamically. This should be sufficient for an SDK that utilizes these models to make decisions or predict outcomes. The SDK ensures that the AI-driven outputs are explainable and aligned with the operational goals, offering transparency into why certain decisions or actions were recommended.
9. Machine-readable Multimedia and ML Nodes: The structured data format should support specific types of nodes for multimedia and machine learning models are designed to be machine-readable, allowing for AI-driven operations without manual intervention.
10. Virtual Sensor Creation: The data in the model should be sufficient to allow an SDK to generate virtual sensors on demand, drawing from the stored environmental data in the model. These virtual sensors can provide alternative perspectives on system performance or environmental data, offering actionable insights for optimizing operations or training experiences.
11. Embedded Data Taxonomy: The data model should provide its own organized taxonomy of data, allowing an SDK to interpret these categories for specific actions, such as optimizing searches, loading data structures, or defining relationships in real time.
12. State/Instance-specific Behaviors: Behavior can vary according to the system's current state or instance, adding to the adaptability in different scenarios.
13. Scenario-based Taxonomy: Categorization based on scenarios or use-cases organizes data for scenario-specific parsing and action.

### Additional Characteristics of the UIF Data Model:

The UIF data model goes beyond the minimum characteristics of a process system complete data model to provide additional novelty and use specific to practical implementation in an enterprise setting.
1. Procedural Generation Capability: The UIF data model stores rules and parameters sufficient to represent a procedural frameworks, enabling an SDK to execute generation processes, ensuring data remains relevant and responsive to the system's operational state.
2. Multi-modal Interaction Recognition: The UIF data model holds multi-modal input configurations, allowing the SDK to interpret and react to these inputs—such as gestures, voice commands, or UI actions—allowing for real-time user interaction with the system.
3. Immutability and Verifiability: The UIF data model maintains an immutable logs of changes and ensures that each version of the data is preserved. Allowing an SDK to then verify changes in real time, checking the validity of updates and tracing their origins without losing past records.
4. Dynamic Learning and Adaptation: The UIF data model provided logs for changes are sufficient to enable model retraining based on new data, ensuring continuous optimization.
5. Structured Data Formats Compatibility: The data model should be expressible in common and future structured data formats, including but not limited to plain-text, binary, streaming, and distributed formats including (but not limited to) YAML, JSON, CSV, TOML, INI, Apache Avro, MessagePack, BSON, CBOR, FlatBuffers, ProtoBuf, Apache Parquet, Optimized Row Columnar, Feather, JSON Lines, Thrift, Google FlatBuffers, and Apache Arrow. See Table 1.

TABLE 1
Summary of Key Formats by Category

| Category | Common Formats |
|---|---|
| Plain-Text | JSON, XML, YAML, CSV, TOML, INI Files, JSON Lines |
| Binary | Protocol Buffers, Apache Avro, MessagePack, BSON, |
| | CBOR, FlatBuffers, Apache Parquet, ORC, Feather, |
| | Apache Arrow, Thrift |
| Streaming | Apache Kafka, JSON Lines, Protocol Buffers, |
| | MessagePack, CBOR |
| Distributed | Apache Avro, Apache Parquet, ORC, Protocol Buffers, |
| | Thrift, MessagePack, FlatBuffers, Apache Arrow |

6. Integration of Deterministic & Probabilistic Systems: The data model stores both deterministic rules and probabilistic system parameters, allowing the SDK to harmonize these systems, ensuring they function correctly and adapt to changing conditions in real time.
7. Integration and Interoperability: To fully realize the potential of a Process-System Complete file, system integration is paramount. SDKs should facilitate this, maintaining the structure's versatility and independence across various platforms.

### G. Components and Functionalities of the UIF

The Universal Instruction Format (UIF) is an adaptive, multi-functional data architecture that serves as the foundation for complex systems requiring real-time task guidance, training, and autonomous operations. The UIF consists of three core components: the UIF data model, the UIF

Software Development Kit (UIF-SDK), and the UIF Deployment Architecture, each serving distinct but complementary purposes.
1. UIF Data Model: The UIF data model is the structured representation of data, encompassing static, dynamic, and temporal information. It organizes and stores data relevant to system states, user inputs, telemetry, and system tasks. The data model supports both predefined and evolving system conditions, ensuring that all necessary data is readily accessible and adaptable based on real-time conditions.
2. UIF SDK: The UIF SDK is the engine that processes and interprets the data contained in the UIF data model. It serves as the execution layer, interacting with external systems, XR applications, and telemetry devices to deliver task guidance, manage autonomous operations, and trigger real-time actions. The SDK allows for dynamic rendering, task sequencing, and AI-driven decision-making based on the data it interprets from the UIF data model.
3. UIF Deployment Architecture: The UIF Deployment Architecture refers to how the UIF system is implemented within a given environment. This includes the methods used for data storage, processing, and application execution. The deployment architecture may vary depending on the use case:
   Local Implementation: UIF can be deployed as a local file system, operating on SSDs or flash storage, with the UIF SDK managing all processes on a single machine.
   Contained XR Application: The system can be implemented as a fully-contained XR application, where the data model and SDK are precompiled and packaged together for a standalone user experience.
   Distributed System: UIF can also be deployed in a distributed manner, where the data model is stored across cloud-based or server systems, and the SDK operates in real time across multiple devices or platforms. This allows for real-time synchronization and large-scale operations.

The deployment architecture dictates the system's scalability, latency, and adaptability, ensuring the appropriate configuration based on the operational needs.
4. File Format(s): The UIF supports multiple file formats, including JSON, XML, and/or other structured formats, ensuring that it remains interoperable across different systems. These formats encapsulate the data model in a way that can be efficiently transmitted and processed by the UIF SDK. The system is capable of serializing complex resources into a single binary stream, allowing for optimized performance.
5. Real-time Data Transmission: The UIF deployment architecture supports real-time data streaming, enabling the system to process partial transmissions before the full file is received. This ensures minimal latency and immediate responsiveness in environments that require rapid adjustments, such as AR/VR or autonomous operations.
6. Integration Tool: By embedding AI/ML models within the data model, the UIF SDK performs intelligent decision-making and real-time optimization. It serves as the integration layer, linking AI models, task engines, and telemetry systems to ensure seamless execution of tasks based on the data provided by the UIF data model.
7. Interoperability Framework: The UIF SDK acts as a bridge between the UIF data model and external systems, enabling interoperability through SDKs and APIs. This ensures compatibility with various IoT devices, telemetry systems, and cloud platforms. The system is designed with future capabilities in mind, supporting unknown technologies or future innovations.
8. Data Persistence: The UIF deployment architecture ensures that data is stored securely and reliably through scalable storage solutions, such as SSDs, flash memory, or dynamic cloud-based storage systems. The system can store and access data in real time, ensuring data integrity and accessibility across platforms.

### H. Example UIF Schema

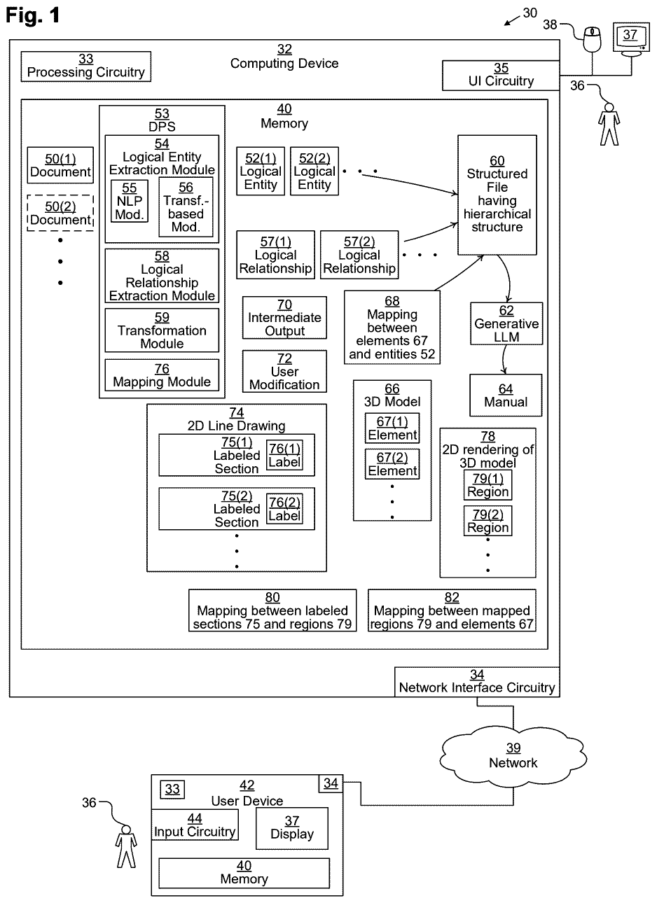

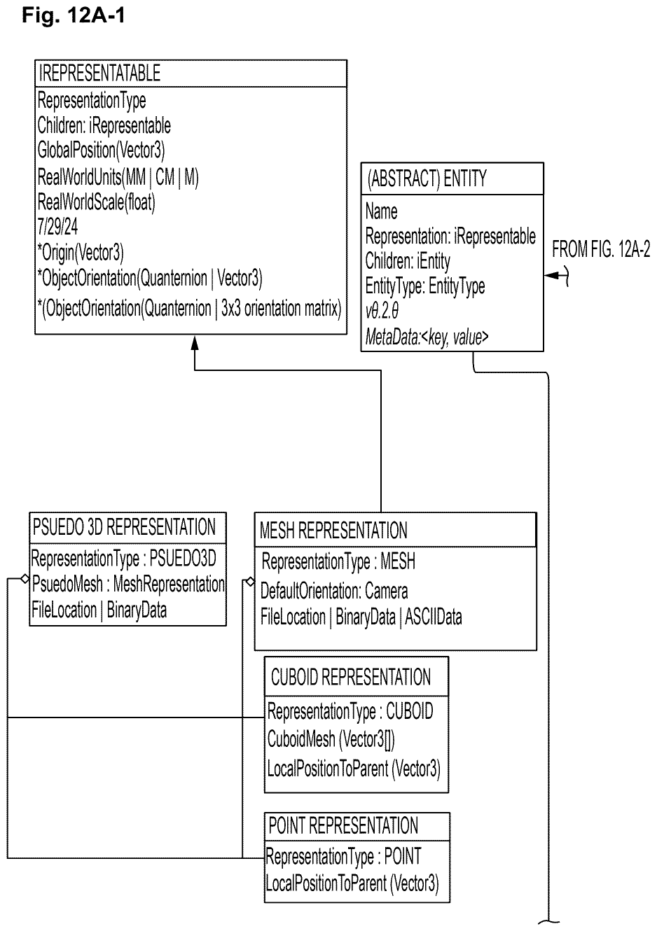

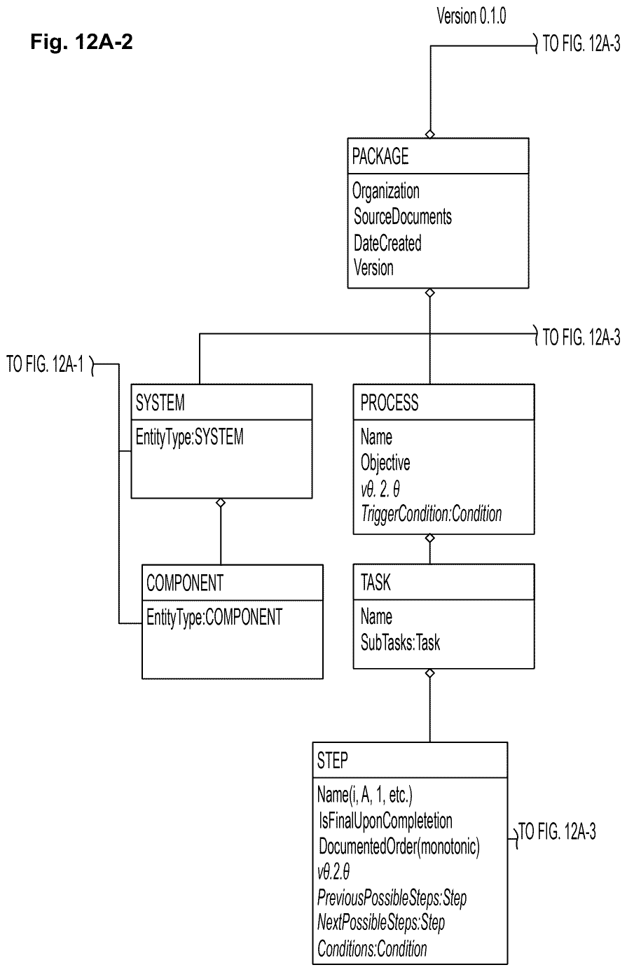

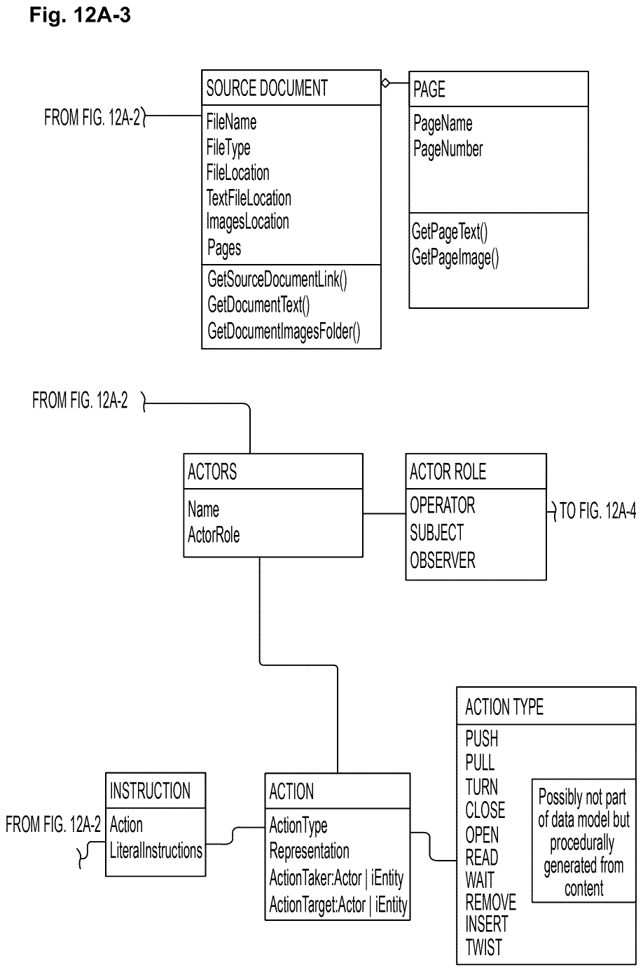

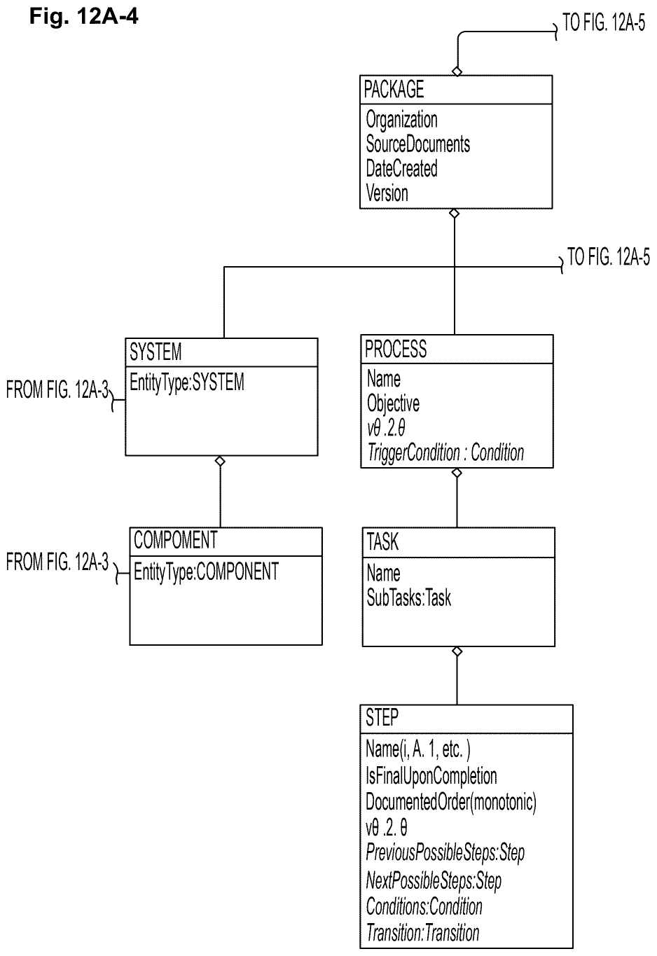

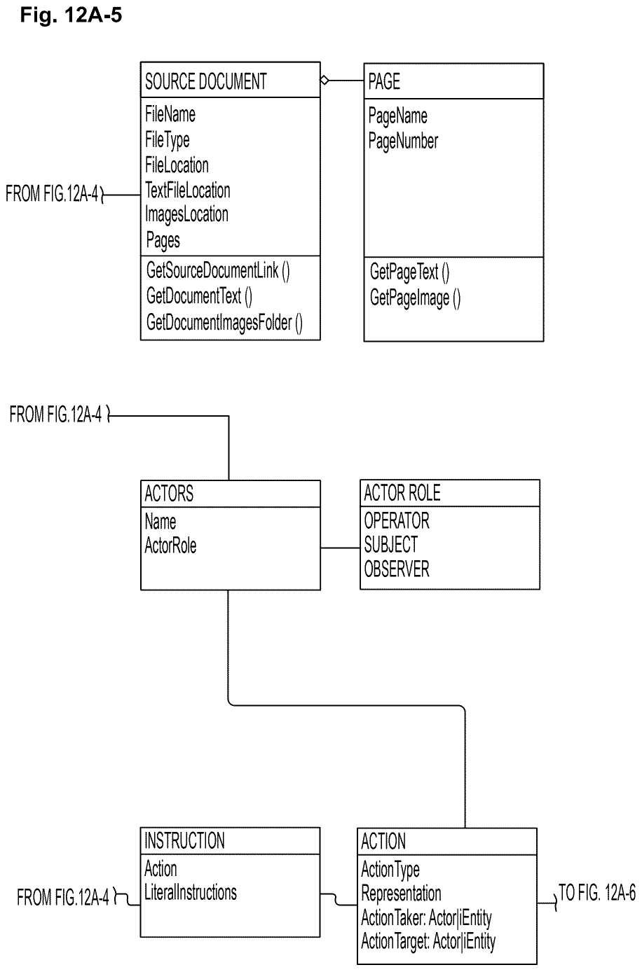

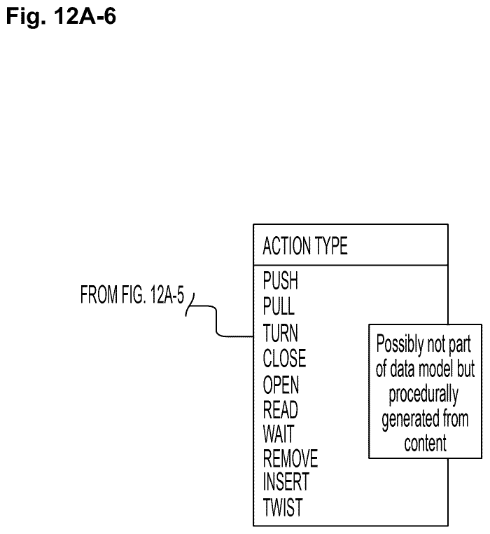

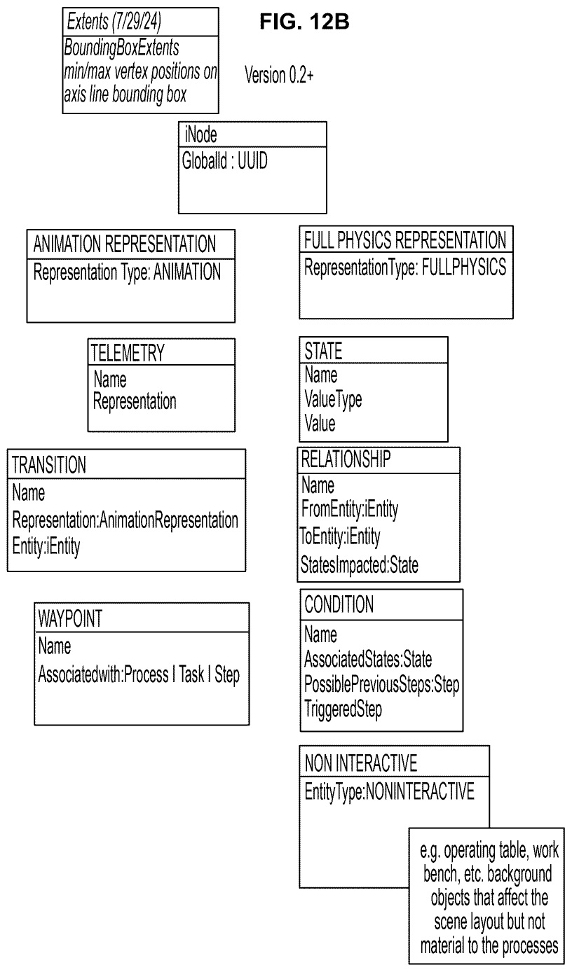

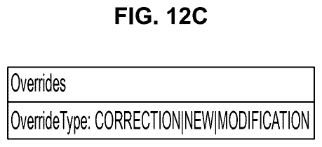

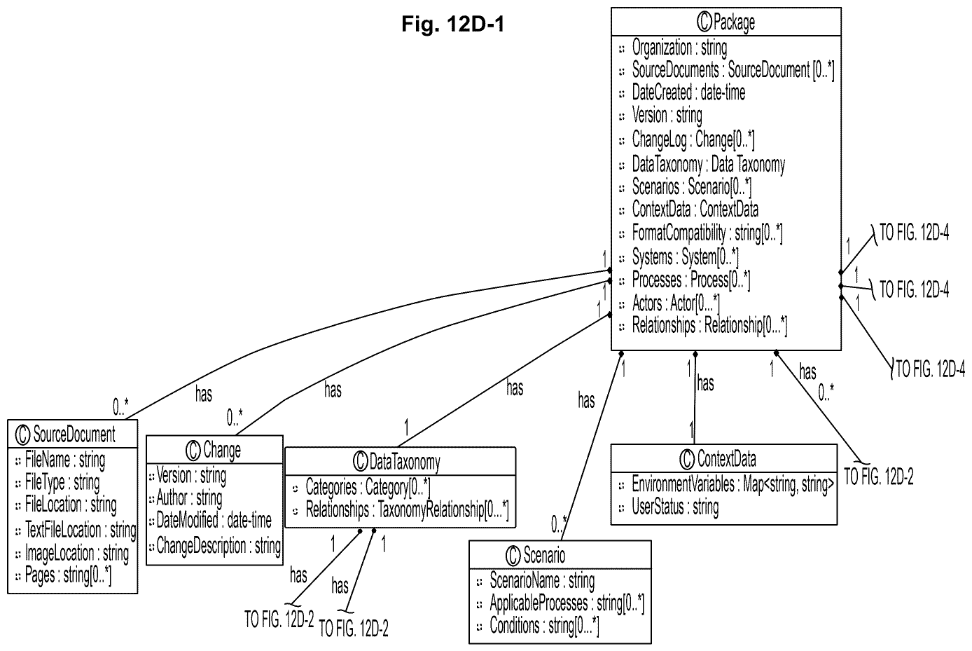

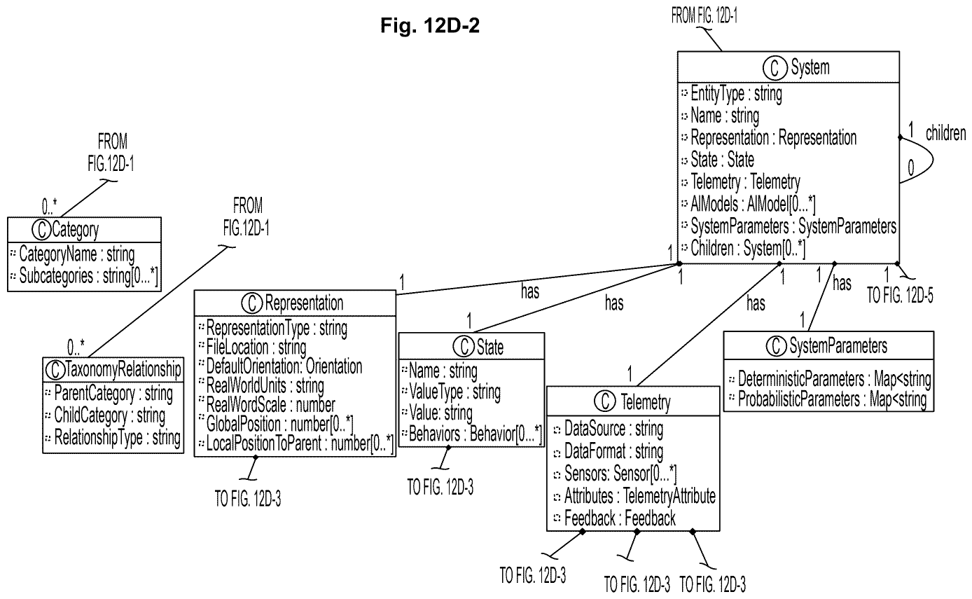

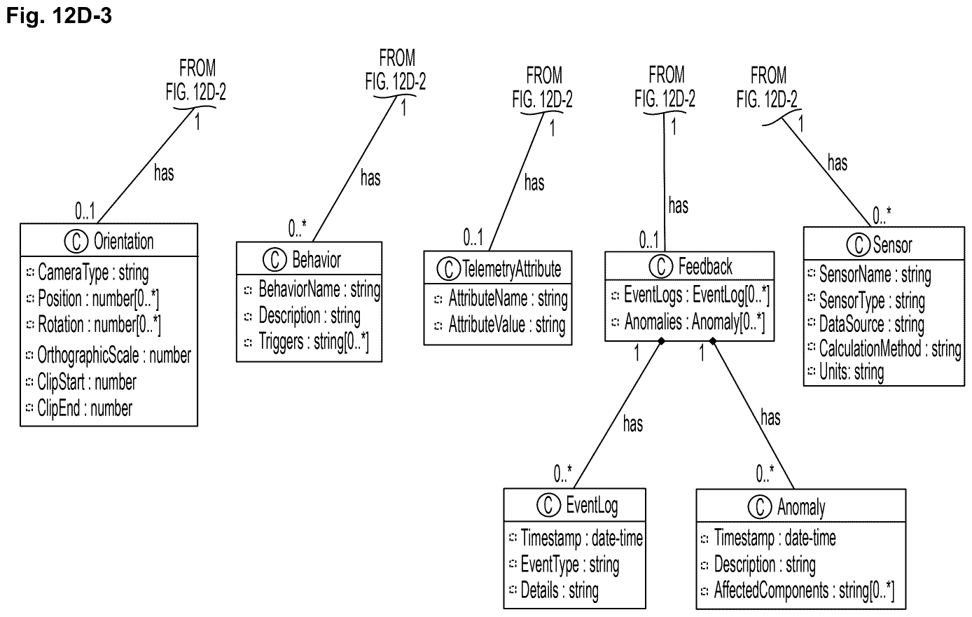

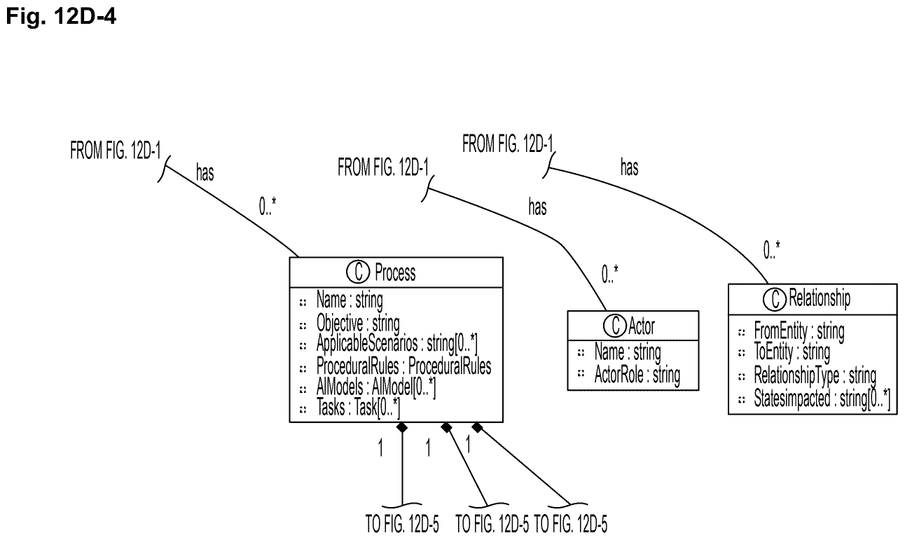

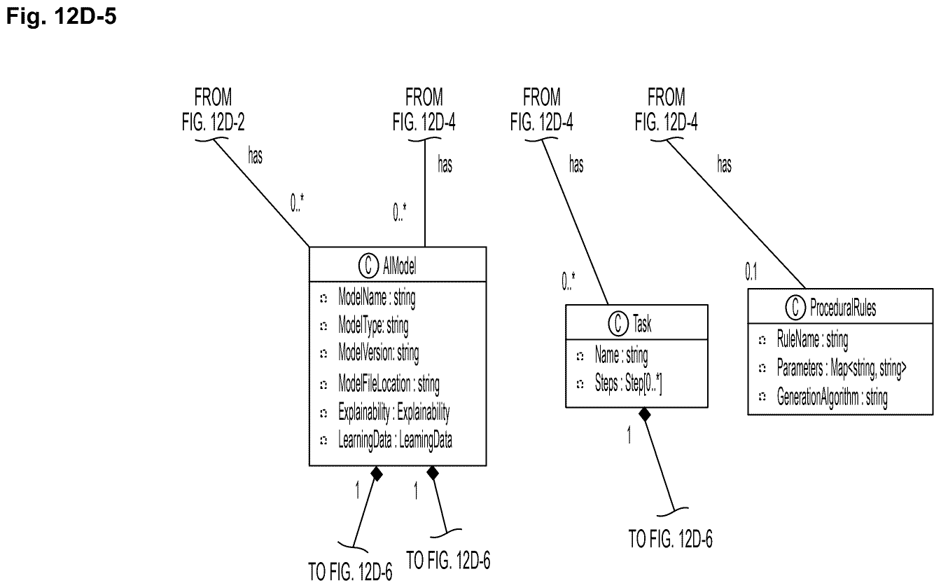

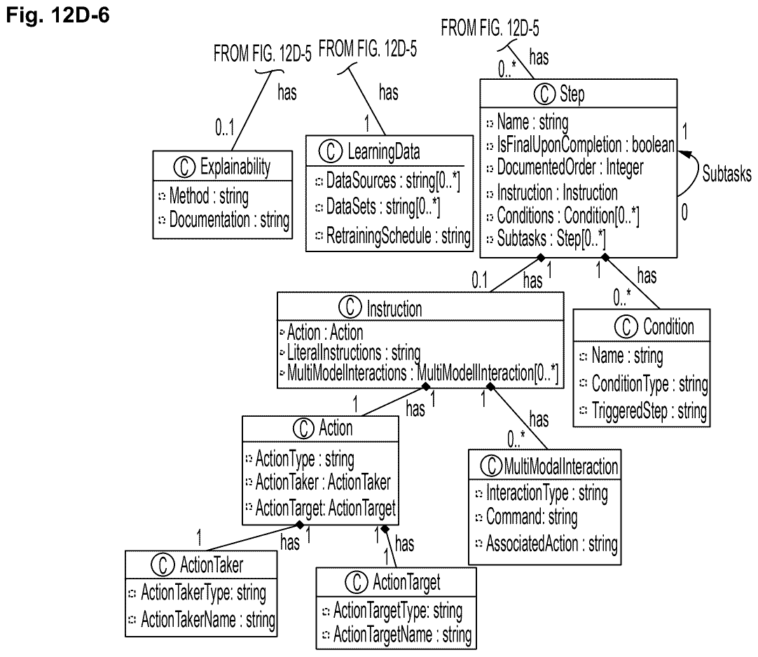

Several example UIF schemas are illustrated in FIGS. 12A-12D. FIG. 12A (broken up into FIGS. 12A-1 through 12A-6) depicts UIF Schema, versions 0.1 and later. FIG. 12B depicts UIF Schema, versions 0.2 and later. FIG. 12C depicts UIF Schema, versions 0.3 and later. FIG. 12D (broken up into FIGS. 12D-1 through 12D-6) depicts UIF Schema, version 1.0.

Computer Program Listing Appendix A contains a code listing of UIF Schema, version 0.3 in JSON format as well as a code listing of UIF Schema, version 1.0 in JSON format.

### I. Summary of Document Processing Service

The Document Processing Service is a key system responsible for converting various traditional and modern data sources into the standardized Universal Instruction Format (UIF) files. This service is designed to handle a wide variety of input types, ensuring they are processed and structured for use in immersive guidance systems, training, task execution, and real-time applications. The Document Processing Service enables multiple features, including:
1. Document Ingestion: The service ingests a wide array of traditional documentation formats, such as PDFs, scanned manuals, and text documents. It converts these into the UIF format, standardizing them for use across XR applications, real-time guidance systems, and autonomous processes.
2. Video and Instructional Content Ingestion: In addition to traditional documents, the system is capable of ingesting instructional videos, live process recordings, and expert walkthroughs, translating these media into structured UIF data that can be used to guide tasks or provide immersive training.
3. Spatial Model Ingestion: The system converts 3D models from CAD formats into UIF-compatible structures for use in virtual, augmented, and mixed reality environments. This process ensures that 3D data can be utilized in XR applications and real-time digital twins. Future capabilities may include support for LIDAR, NERFs (Neural Radiance Fields), and other cutting-edge 3D capture technologies, allowing for a broad spectrum of data sources to be integrated seamlessly.
4. Real-time Observational Data: The system can also ingest real-time observational data, captured from live processes or sensor systems, and convert this into UIF data. This ensures that the UIF can be updated based on real-time input from physical environments or operations, further enhancing task guidance and autonomous operations.
5. Data Processing: After ingestion, the service processes all inputs, whether they are documents, videos, 3D models, or observational data, structuring them according to the UIF data model. This enables interoperability and ensures that the data can be utilized across a range of systems, including XR task guidance, autonomous operations, and AI-driven applications.

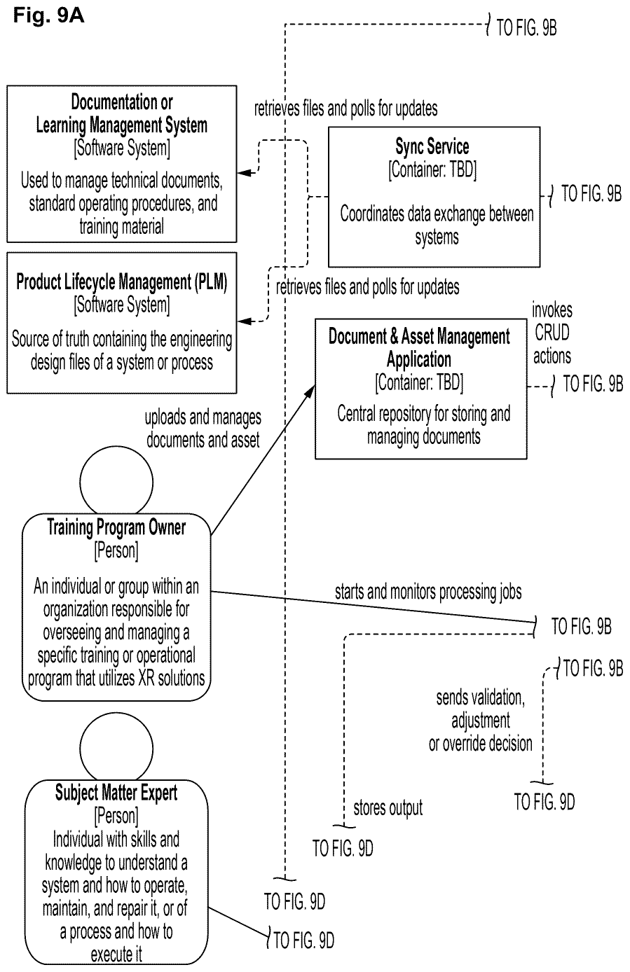

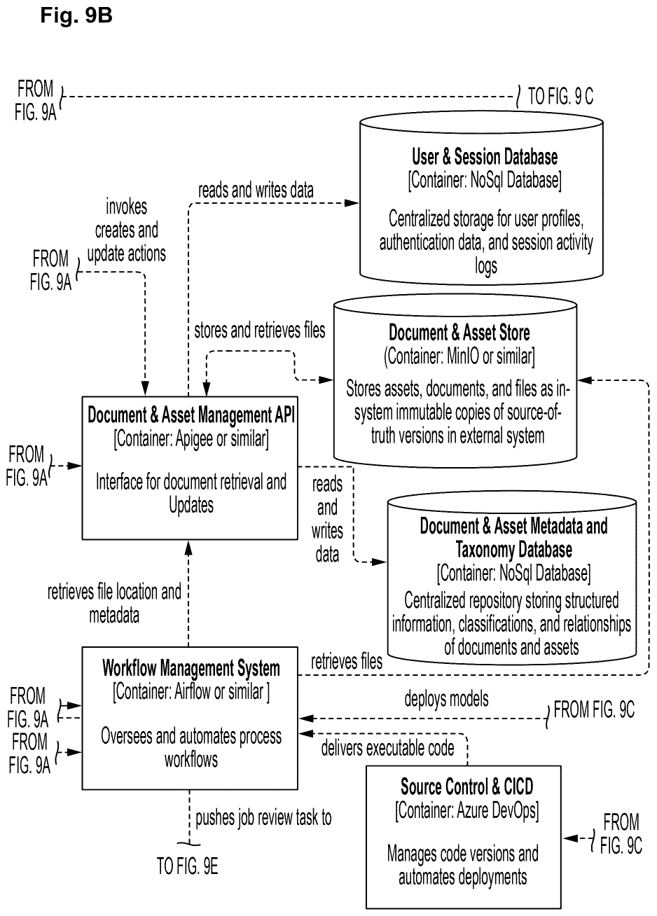

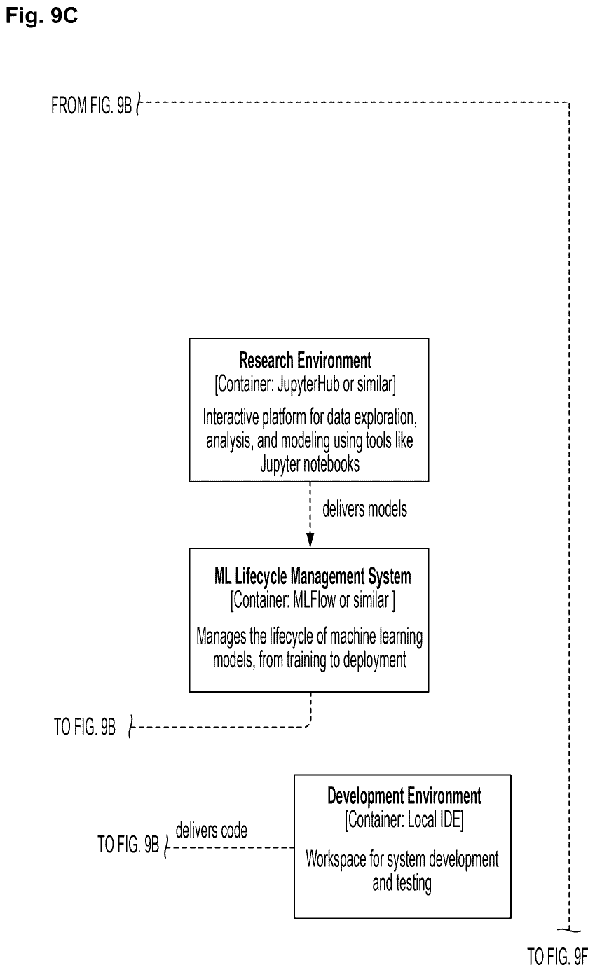

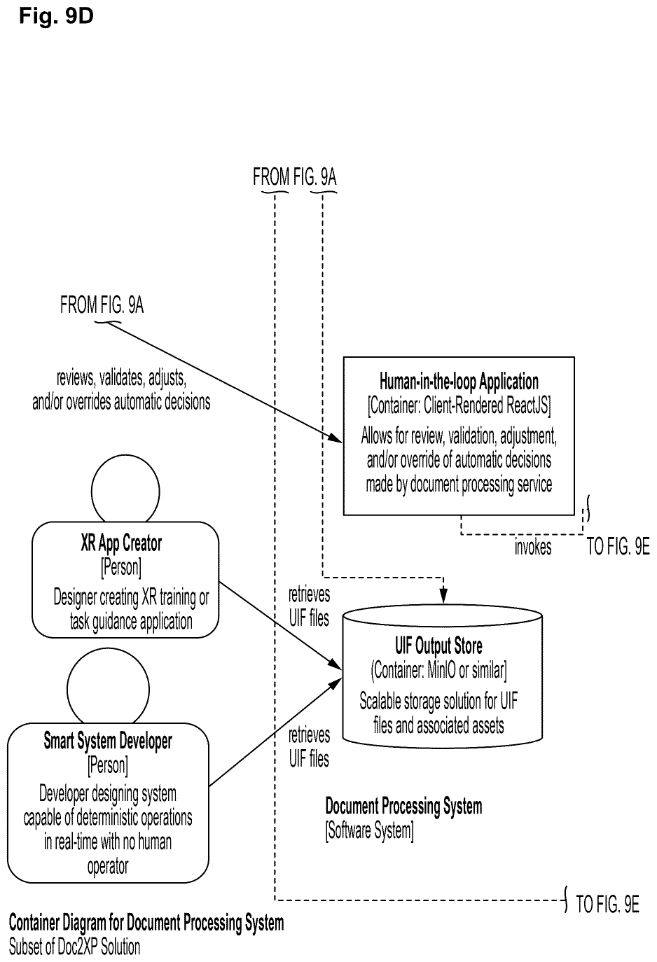

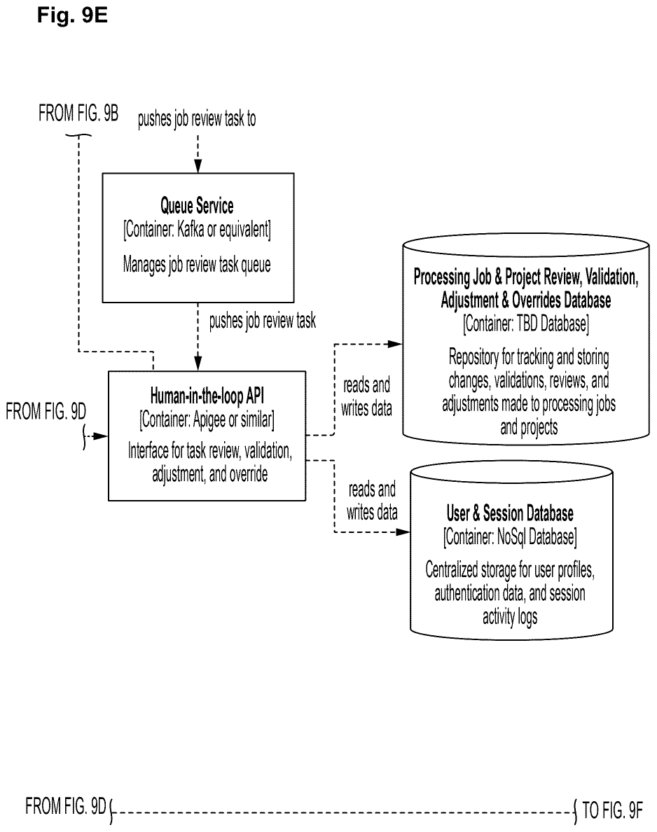

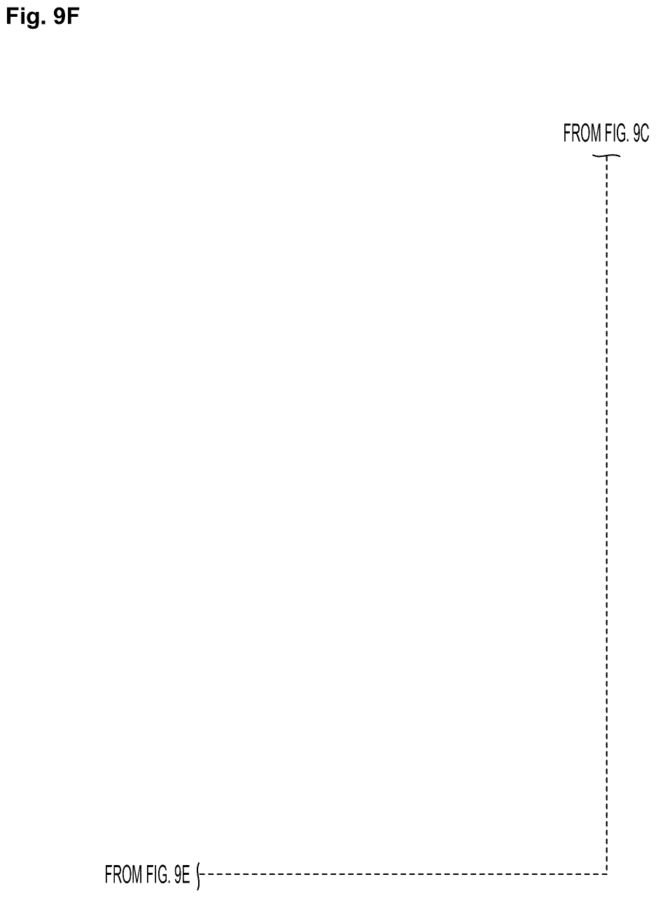

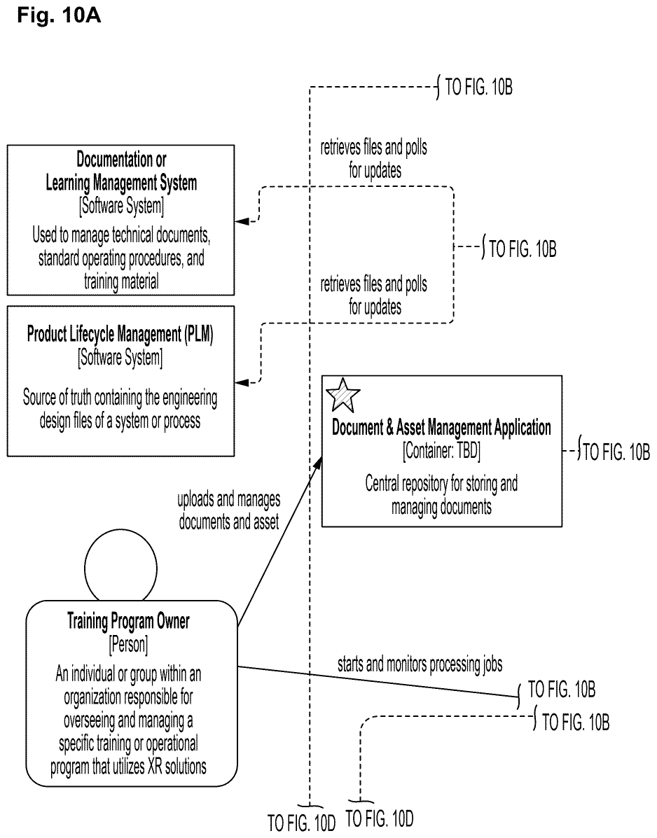

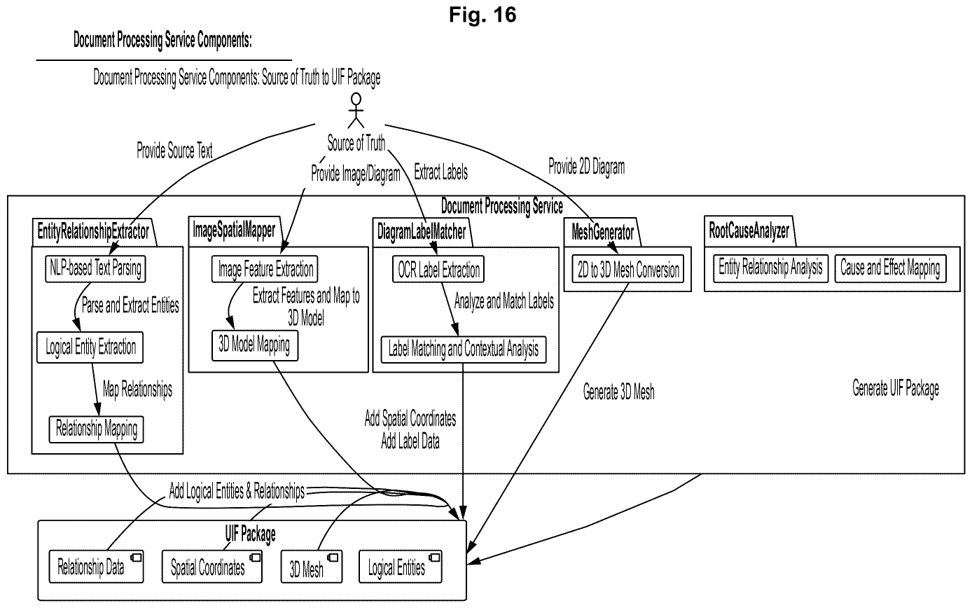

FIGS. 9 (broken up into FIGS. 9A-9F) and 16 are diagrams depicting example architectures of the DPS according to one or more embodiment.

### J. Human-In-the-Loop System

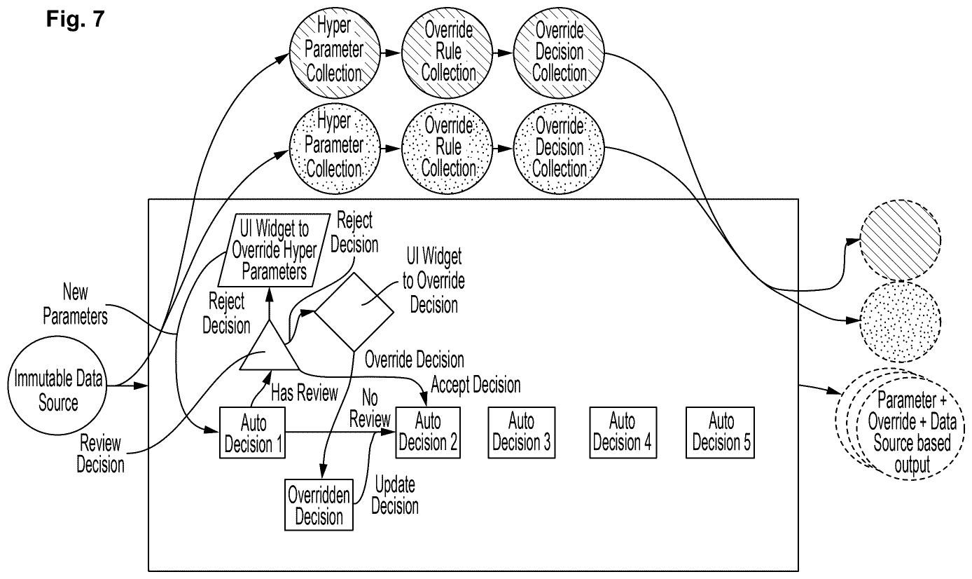

The Human-in-the-loop (HITL) system is an important part of the DPS, ensuring that human intervention can take place during automated document processing tasks. This system provides the user with the ability to review, accept, override, or modify decisions made by the automated DPS. It is particularly useful in maintaining flexibility and control during the conversion of trusted data sources into the UIF package, allowing users to ensure the highest accuracy in the processing of documents. FIG. 7 illustrates the HITL system.

### Key Steps in the HITL Workflow:

1. Automated Task Execution:
   The DPS automatically performs predefined tasks, such as extracting logical entities, organizing content, and/or applying pre-established workflows to convert the data into the UIF package format.
   During this process, decisions about structuring data, extracting information, or applying specific transformations are made by the system based on machine learning models or preset rules.
2. Human Review and Override:
   When the system completes a task or reaches a decision point that requires validation, the HITL system prompts a human operator to review the automated task.
   The operator can then:
      Accept the system's task as-is, allowing it to proceed with the next step in the document processing pipeline.
      Override the decision, providing manual corrections or adjustments.
3. Save and Apply Overrides:
   After making manual changes or overrides, the operator has the option to:
      Save the override for this specific document: The override will only apply to this document, allowing future processing of this document to reflect the operator's input.
      Save the override for the entire project: This override will apply to all related documents within the project, ensuring that future documents processed under the same project will follow the corrected parameters.
   This option gives the operator flexibility to apply corrections or rules across multiple documents or limit them to a single document, maintaining precision in project management.
4. Hyperparameter Adjustment:
   In addition to accepting or overriding the system's decisions, the human operator can adjust hyperparameters within the document processing model.
   Hyperparameters might include thresholds for entity extraction, model confidence levels, or settings related to the structuring of information.
   Similar to task overrides, hyperparameter adjustments can be saved:
      For this document only: Changes to hyperparameters will apply to the current document being processed.
      For future documents within the project: Hyperparameter adjustments will be applied to all documents processed under the same project, ensuring that future tasks are optimized based on user input.
5. Continuous Learning and Feedback Loop:
   The system captures all human interventions, including task overrides and hyperparameter adjustments, in a feedback loop.
   This feedback may be used to improve the DPS over time, enabling it to learn from human corrections and fine-tune its automation processes for future document processing tasks.
   The feedback loop allows the system to become increasingly efficient and accurate, minimizing the need for future human intervention in similar tasks.
6. Audit and Tracking:
   Every human intervention, whether it's an override, adjustment of hyperparameters, or a saved decision, may be logged in an audit trail.
   The audit system ensures that all changes and manual interventions are tracked for future reference, regulatory compliance, or project transparency.

### Steps:

1. Immutable Data Source: This represents an unchanging repository or database where the raw data or documents are stored.
2. Hyper Parameter Collection: This section includes: Hyper Parameter Collection (Red & Yellow Circles): These indicate parameters or configurations that affect the decision-making process. They refer to things like thresholds, conditions, or values used to guide the automated processing of documents.
3. Override Section: This involves three components:
   Override Rule Collection: Rules that are set to override any automatic decision or processes.
   Override Decision Collection: This refers to the repository of past override decisions that can guide or influence future decisions.
   UI Widget to Override Decision: This is a user interface component that allows a human operator to intervene and override a decision.
4. Decision Review and Override Workflow:
   Review Decision: Before a decision is finalized, it can optionally undergo a review process.
   UI Widget to Override Hyper Parameters: Another user interface component, but this one allows for overriding the hyperparameters.
   Auto Decision: This represents automated decision or processes that is carried out based on the provided data and set parameters.
   Overridden Decision: If an automated decision is overridden by a human, it will be captured and stored here.
5. Output: Parameter+Override+Data Source based output: This is the final output after considering the parameters, any overrides, and the data source. It is the culmination of the HITL process.

### 2. System Architecture

FIG. 1 is a block diagram of an example of a system 30 according to an embodiment. In an embodiment, the system 30 may include more or fewer components than the components illustrated in FIG. 1. System 30 includes a computing device 32 as well as a display screen 37 operated by a user 36 (e.g., an SME).

In some embodiments, the screen 37 may be connected to the computing device 32 via user interface circuitry 35, the user 36 also having access to one or more input devices 38 also connected to the computing device 32 via the user interface circuitry 35.

In other embodiments, user 36 and display 37 are remote from the computing device 32. In these embodiments, the user 36 operates a user device 42 that is connected to a network 39 via network interface circuitry 34, and computing device 32 also connects to network 39 via its own network interface circuitry 34, allowing the user device 42 and the computing device to communicate. In some embodiments (as depicted), the display 37 is embedded within the user device 42 (e.g., a smart phone), the user device 42 also including embedded input circuitry 44 (e.g., a touchscreen).

Computing device 32 and user device 42 may each be any kind of computing device, such as, for example, a personal computer, laptop, workstation, server, enterprise server, tablet, smartphone, router, etc. In an example embodiment, computing device 32 is a personal computer or server, and user device is a personal; computer, laptop, or smartphone.

Network 39 may be any kind of communications network or set of communications networks, such as, for example, a LAN, WAN, SAN, a wireless communication network, a virtual network, a fabric of interconnected switches, etc. In one embodiment, network 39 may be the Internet.

Computing device 32 and user device 42 may each include processing circuitry 33, network interface circuitry 34, user interface (UI) circuitry 35, and memory 40. Computing device 32 and user device 42 may also include various additional features as is well-known in the art, such as, for example, interconnection traces and buses, etc.

Processing circuitry 33 may include any kind of processor or set of processors configured to perform operations, such as, for example, a microprocessor, a multi-core microprocessor, a digital signal processor, a field-programmable gate array (FPGA), a system on a chip (SoC), a collection of electronic circuits, a similar kind of controller, or any combination of the above.

Network interface circuitry 34 may include one or more Ethernet cards, cellular modems, Fibre Channel (FC) adapters, InfiniBand adapters, wireless networking adapters (e.g., Wi-Fi), and/or other devices for connecting to a network 39.

UI circuitry 35 may include any circuitry needed to communicate with and connect to one or more user input devices 38 and display screens 37. UI circuitry 35 may include, for example, a keyboard controller, a mouse controller, a touch controller, a serial bus port and controller, a universal serial bus (USB) port and controller, a wireless controller and antenna (e.g., Bluetooth), a graphics adapter and port, etc.

Display screen 37 may be any kind of display, including, for example, a CRT, LCD screen, LED screen, etc. Input device 38 may include a keyboard, keypad, mouse, trackpad, trackball, pointing stick, joystick, touchscreen (e.g., embedded within display screen 37), microphone/voice controller, etc. In some embodiments, instead of being external to computing device 32, the input device 38 and/or display screen 37 may be embedded within the computing device 32 (e.g., a cell phone or tablet with an embedded touchscreen, as depicted in connection with user device 42).

Memory 40 may include any kind of digital system memory, such as, for example, random access memory (RAM). Memory 40 stores an operating system (OS, not depicted, e.g., a Linux, UNIX, Windows, MacOS, or similar operating system) and various drivers and other applications and software modules configured to execute on processing circuitry 33 as well as various data.

Memory 40 of computing device 32 stores a document processing service (DPS) 53, which may include a logical entity extraction module (LEEM) 54, a logical relationship extraction module (LREM) 58, a transformation module 59, and/or a mapping module 76. LEEM 54 may include a natural language processing (NLP) module 55 and/or a transformer-based model 56.

In operation, user 36 provides a set of one or more documents 50 (depicted as documents 50(1), 50(2) . . . ). Documents may include text-based documents, such as text files, word processing files (e.g., Microsoft Word format), formatted document files (e.g., Adobe PDF, etc.); images, such as photographs, vector drawings, etc.; videos; etc.

LEEM 54 operates to process the set of documents 50 and extract a plurality of logical entities 52 (depicted as logical entities 52(1), 52(2) . . . ) therefrom according to a predefined schema (e.g., UIF schema). Logical entities 52 represent physical or logical components of a product or system. For example, logical entities 52 of a standard pencil might include a graphite core (physical), a wooden encasement (physical), a metallic eraser-holder (physical), an eraser (physical), a writing end (logical), and an erasing end (logical). Logical entities 52 may also represent a process performed by the product or system. Thus, additional logical entities 52 of a standard pencil might also include writing (process) and erasing (process). Each logical entity 52 includes a definition.

LREM 58 operates to process the set of documents 50 and extract a plurality of logical relationships 57 (depicted as logical relationships 57(1), 57(2), . . . ) therefrom according to a predefined schema (e.g., UIF schema). Logical relationships 57 represent logical or spatial relationships between the logical entities 52 of a product or system. For example, logical relationships 57 of a standard pencil might include the wooden encasement surrounding the graphite core (spatial), the metallic eraser-holder partially surrounding the wooden encasement and the eraser (spatial), the graphite core being exposed at the writing end (spatial), the eraser being exposed at the erasing end (spatial), the graphite core being used to perform writing (logical), the eraser being used to perform erasing (logical), etc. Each logical relationship 57 includes a definition.

In some embodiments, LEEM 54 and LREM 58 operate by initially generating an intermediate output 70, such as an initial assignment of logical entities 52 or logical relationships 57, respectively. In some embodiments, the intermediate output 70 may also include a set of hyperparameters (not depicted) used to perform the logical entity extraction or logical relationship extraction procedures. This intermediate output 70 can be displayed to the user 36 (e.g., on screen 37). The user 36 is then able to (e.g., using input device 38 or input circuitry 44) to input one or more user modifications 72. In one embodiment, a user modification 72 may be an instruction to explicitly alter one or more of the logical entities 52 and logical relationships 57 or their respective definitions. In another embodiment, a user modification 72 may be an instruction to alter one of the hyperparameters. In response to receiving the one or more user modifications 72, LEEM 54 and/or LREM 58 may operate to update the set of logical entities 52 and/or logical relationships 57 accordingly.

Memory 40 may also store one or more 2-dimensional (2D) line drawing 74 (or vector-based drawing) of a product as well as a 3D model 66 of the product. In some embodiments, the 2D line drawing 74 is embedded within one of the documents 50 (e.g., a diagram within a user manual). In other embodiments, the 2D line drawing 74 may be its own entire document 50. It should be noted that although described as a “line drawing.” 2D line drawing 74 may include additional features, such as shading.

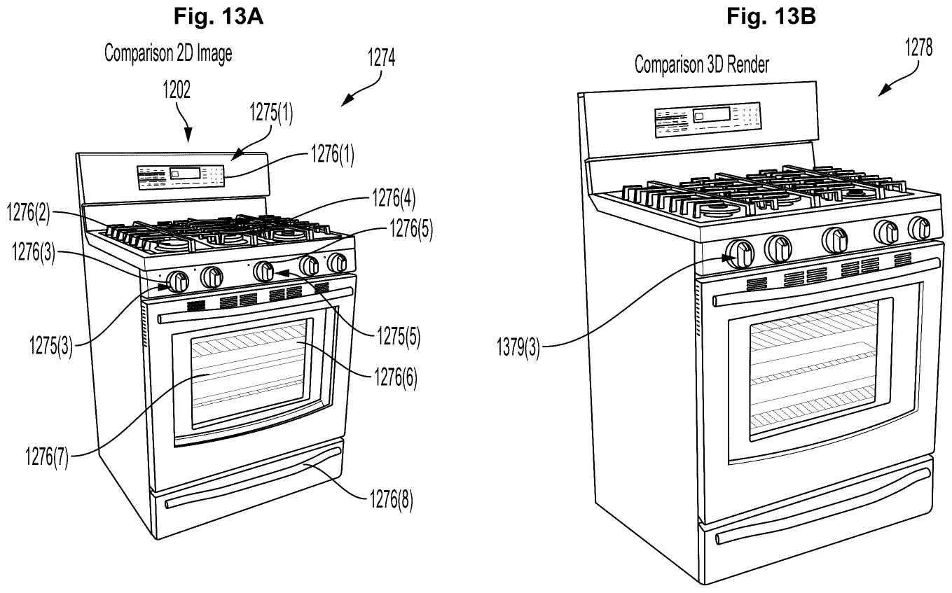

2D line drawing 74 includes a plurality of labeled sections 75 (depicted as labeled sections 75(1), 75(2), . . . ), each one having a corresponding label 76 (depicted as labels 76(1), 76(2) . . . ). For example, with reference to FIG. 13A, 2D line drawing 74 of an oven 1202 includes eight labeled sections 1275 (only two of which are labeled as such), each one having a corresponding label 1276 (labeled 1-8), such as the upper backguard section 1275(1) (labeled as “1” with label 1276(1)) and the knobs section 1275(5) (labeled as “5” with label 1276(5)). 3D model 66 may include a wireframe or mesh model of the product as well as surface texture information. Various 3D modeling formats may be used, such as, for example, 3DS or OBJ. In some embodiments, 3D model 66 may be provided by the user 36, while in other embodiments, 3D model 66 may be generated based on the 2D line drawing 74 (e.g., using photogrammetry). 3D model 66 includes elements 67 (depicted as elements 67(1), 67(2), . . . ), which may be spatial regions bounded by a geometric boundary that represent features of a product.

Mapping module 76 operates to generate a mapping 68 between one or more of the logical entities 52 and one or more of the elements 67 of the 3D model 66 with reference to the 2D line drawing 74. This may be accomplished by identifying which labels 76 correspond to which logical entities 52, finding a set of best camera parameters (e.g., camera position, camera direction, and type of projection) with which to render the 3D model 66, rendering the 3D model 66 using that set of parameters to generate a 2D rendering 78, generating a mapping 80 between the labeled sections 75 and regions 79 (depicted as regions 79(1), 79(2), . . . ) of the 2D rendering 78, generating another mapping 82 between the mapped regions 79 of the 2D rendering 78 and elements 67 of the 3D model, and combining this information into mapping 68.

Transformation module 59 operates to transform the logical entities 52, logical relationships 57, and/or mapping 68 into a structured file 60 having a hierarchical structure, such as a UIF file, as described above and in Computer Program Listing Appendix A.

In some embodiments, the structured file 60 (or alternatively, the logical entities 52, logical relationships 57, and/or mapping 68, directly) may be input into a generative large language model (LLM) 62 to generate a user manual 64 (also referred to as a product manual or technical manual). In these embodiments, the set of documents 50 typically does not already contain a user manual 64. In other embodiments, the set of documents 50 includes a user manual 64, so there is no need to use the generative LLM 62 to generate the user manual 64. In some embodiments, generative LLM 62 may have been trained on large dataset of user manuals.

Memory 40 may also store various other data structures used by the OS, DPS 53, LEEM 54, LREM 58, transformation module 59, mapping module 76, NLP module 55, generative LLM 62, transformer-based model 56, and/or various other applications and drivers. In some embodiments, memory 40 may also include a persistent storage portion. Persistent storage portion of memory 40 may be made up of one or more persistent storage devices, such as, for example, magnetic disks, flash drives, solid-state storage drives, or other types of storage drives. Persistent storage portion of memory 40 is configured to store programs and data even while the computing device 32 or user device 42 is powered off. The OS, DPS 53, LEEM 54, LREM 58, transformation module 59, mapping module 76, NLP module 55, generative LLM 62, transformer-based model 56, and/or various other applications and drivers are typically stored in this persistent storage portion of memory 40 so that they may be loaded into a system portion of memory 40 upon a system restart or as needed. The OS, DPS 53, LEEM 54, LREM 58, transformation module 59, mapping module 76, NLP module 55, generative LLM 62, transformer-based model 56, and/or various other applications and drivers, when stored in non-transitory form either in the volatile or persistent portion of memory 40, each form a computer program product. The processing circuitry 33 running one or more applications thus forms a specialized circuit constructed and arranged to carry out the various processes described herein.

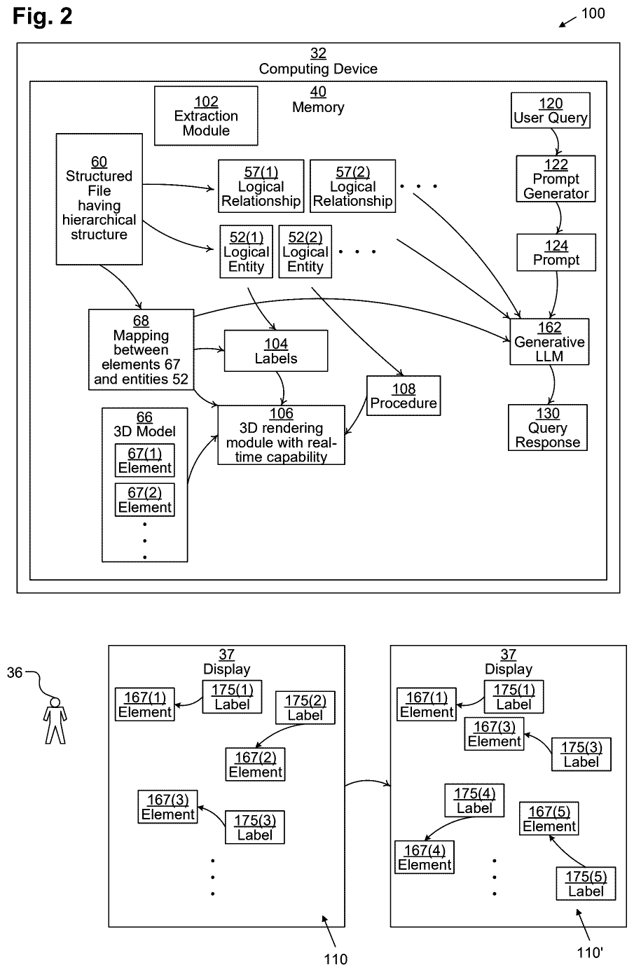

FIG. 2 depicts a system 100. System 100 may include some of the same components as system 30, such as computing device 32, user device 42 (not depicted in FIG. 2), display 37, and user 36. In some embodiments, the computing device 32, user device 42, display 37, and/or user 36 of system 100 are the same as the respective computing device 32, user device 42, display 37, and/or user 36 as in system 30, while in other embodiments, one or all of these may be different. Certain elements have been omitted from FIG. 2 (e.g., internal components of computing device 32, all of user device 42, input device 38, etc.) for clarity.

In the embodiment of system 100, computing device 32 stores the structured file 60 that was generated by system 30 in its memory 40. In some embodiments, structured file 60 remains in place from FIG. 1, while in other embodiments, it is copied to another computing device 32 having a similar configuration. Memory 40 also stores an extraction module 102 and 3D rendering module 106 with real-time capability.

In operation, extraction module 102 runs on computing device 32 to extract the logical entities 52, logical relationships 57, and/or mapping 68 that were encoded in structured file 60. Extraction module 102 may also extract labels 104 from the definitions of the logical entities 52 with reference to the mapping 68 between the elements 67 of the 3D model 66 and the logical entities 52.

In some embodiments, computing device 32 also stores the 3D model 66 in its memory 40. In some embodiments, 3D model 66 remains in place from FIG. 1, while in other embodiments, it is copied to another computing device 32 having a similar configuration. In operation, in one embodiment, 3D rendering module 106 renders the 3D model 66 for display on screen 37 together with appropriate labels 104 linked to the elements 67 that correspond to the logical entities 52 having those labels, updating over time.

For example, as depicted in FIG. 2, screenshot 110 at time T₁ shows on display screen 37 various rendered elements 167(1), 167(2), 167(3) from the 3D model 66 in a first orientation/configuration, and each rendered element 167(1), 167(2), 167(3) has a corresponding label 175(1), 175(2), 175(3) displayed alongside it. Then, at time T₂, after user 36 has used input device 38 or input circuitry 44 to manipulate the product, screenshot 110′ shows on display screen 37 various rendered elements 167(1), 167(3), 167(4), 167(5) from the 3D model 66 in a second orientation/configuration based on the manipulation (e.g., a view is changed or an element 67 is moved), and each rendered element 167(1), 167(3), 167(4), 167(5) has its corresponding label 175(1), 175(3), 175(4), 175(5) displayed alongside it. Note that rendered element 167(2) has disappeared, as depicted, due to no longer being visible in the new view of the second orientation/configuration, rendered element 167(3) has changed position, and rendered elements 167(4), 167(5) are newly visible due to now becoming visible in the new view of the second orientation/configuration.

In another embodiment, 3D rendering module 106 illustrates a procedure 108 encoded in one of the logical entities 52 by rendering rendered elements 167(1), 167(2), 167(3) in screenshot 110 on display screen 37 based on a first configuration of procedure 108 at time T₁, and rendering rendered elements 167(1), 167(3), 167(4), 167(5) in screenshot 110′ on display screen 37 based on a second configuration of procedure 108 at time T₂.

In another embodiment, user 36 queries an intelligent assistant program with a query 120 about the product encoded within the structured file 60. Prompt generator 122 runs on computing device to generate a prompt 124 that it feeds into a generative LLM 162 together with the sets of logical entities 52 and logical relationships 57 and the mapping 68 between the elements 67 and the logical entities 52. Generative LLM 162 is then able to answer the user query 120 while spatially-aware of the configuration of the product.

Memory 40 may also store various other data structures used by the extraction module 102, 3D rendering module 106, prompt generator 122, generative LLM 162, and/or various other applications and drivers. The extraction module 102, 3D rendering module 106, prompt generator 122, generative LLM 162, and/or various other applications and drivers are typically stored in this persistent storage portion of memory 40 so that they may be loaded into a system portion of memory 40 upon a system restart or as needed. The extraction module 102, 3D rendering module 106, prompt generator 122, generative LLM 162, and/or various other applications and drivers, when stored in non-transitory form either in the volatile or persistent portion of memory 40, each form a computer program product. The processing circuitry 33 running one or more applications thus forms a specialized circuit constructed and arranged to carry out the various processes described herein.

### 3. System Operation

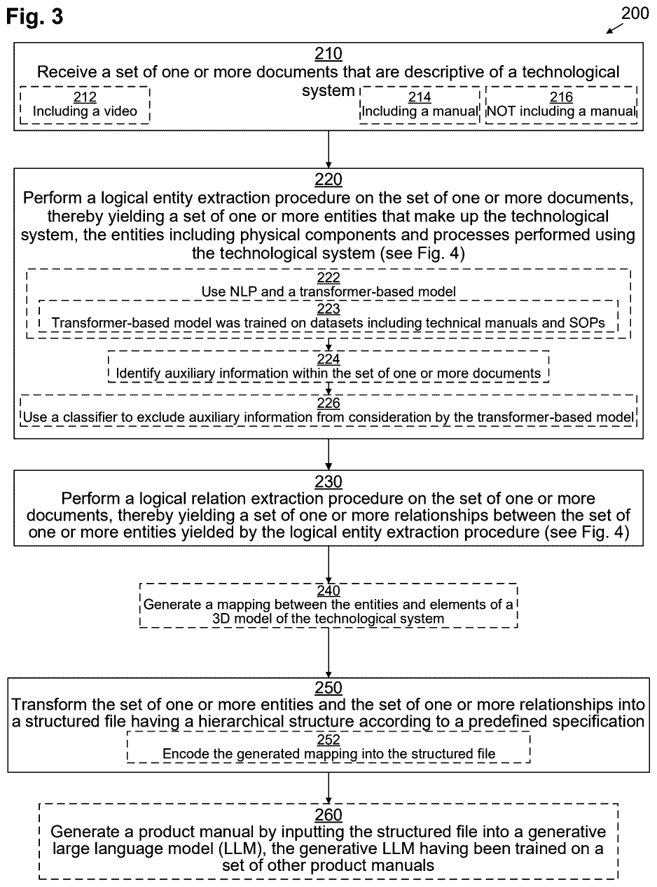

FIG. 3 illustrates an example method 200 performed by computing device 32 of system 30 for processing documents 50. It should be understood that any time a piece of software (e.g., OS, DPS 53, LEEM 54, LREM 58, transformation module 59, mapping module 76, NLP module 55, generative LLM 62, transformer-based model 56, extraction module 102, 3D rendering module 106, prompt generator 122, generative LLM 162, etc.) is described as performing a method, process, step, or function, what is meant is that a computing device (e.g., computing device 32, user device 4, etc.) on which that piece of software is running performs that method, process, step, or function when executing that piece of software on its processing circuitry 33. It should be understood that one or more of the steps or sub-steps of method 200 (especially steps and sub-steps indicated by dashed lines) may be omitted in some embodiments. Similarly, in some embodiments, one or more steps or sub-steps may be combined together or performed in a different order.

In step 210, DPS 53 receives a set of one or more documents 50 that are descriptive of a technological system (e.g., a product). In some embodiments, in sub-step 212, one of the documents 50 that is received is a video. In one embodiment, in sub-step 214, one of the documents 50 that is received is a manual 64. In another embodiment, none of the documents 50 that is received is a manual 64.

The documents 50 represent trusted sources of truth. These are the foundational content sources, including static documents (e.g., PDFs, text files, diagrams, 3D models), dynamic documents, machine learning models, or database records. These sources provide verified data that can be translated into the UIF structure for use in XR experiences, AI assistance, or autonomous operations. While static documents are supported, the system is designed to accommodate trusted, evolving sources as well.

In step 220, LEEM 54 performs a logical entity extraction procedure on the set of one or more documents 50, thereby yielding a set of one or more entities 52 that make up the technological system, the entities 52 including physical and logical components and processes performed using the technological system.

In step 230, LEEM 54 performs a logical relationship extraction procedure on the set of one or more documents 50, thereby yielding a set of one or more relationships 57 between the set of one or more entities 52 from the logical entity extraction procedure 220.

In some embodiments, steps 220 and 230 include sub-steps 222, 224, 226.

In sub-step 222, DPS 53 uses its NLP module 55 to perform natural language processing as well as transformer-based model 56 (e.g., BERT or GPT). The ability to extract logical entities 52 and their relationships 57 from text documents provides a machine readable, structured foundation for the UIF data model. This process utilizes advanced NLP techniques and machine learning algorithms to parse the text, identify key entities 52 such as components, actions, and instructions, and determine the relationships 57 between them. By analyzing the syntactic and semantic structure of the document 50, the system can accurately map out hierarchical instructions, component interactions, and procedural steps. LLM and other AI models may be used to classify and extract various components of a document 50 such as table of contents, page numbers, hierarchical instructions, diagrams, component names, etc. Specifically, transformer-based models like BERT or GPT may be employed (sub-step 223) to understand the context and semantics of the text, enabling precise classification and extraction of relevant sections. These models are trained on large datasets to recognize patterns and structures typical of technical manuals and SOPs.

In sub-step 224, DPS 53 identifies auxiliary information within the set of documents 50 that is not relevant to the extraction process, e.g., through a combination of rule-based filters and machine learning classifiers that differentiate between essential instructional content and auxiliary information such as disclaimers, multilingual sections, or decorative text. Examples of excluded information could include identical instructions in a different language, structured blocks of text that orient users such as callouts that an instruction is of high importance, etc.

Then, in sub-step 224, DPS 53 excludes the auxiliary information from consideration by the transformer-based model.

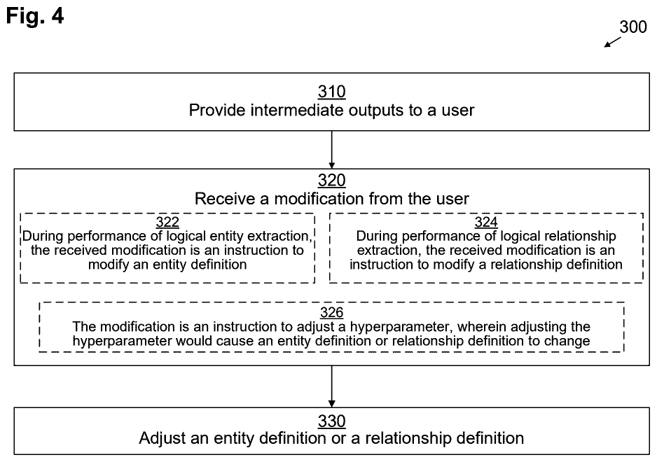

In some embodiments, steps 220 and 230 may include method 300, illustrated in FIG. 4. Method 300 implements an HITL feature. In step 310, DPS 53 provides intermediate outputs 70 to the user 36.

Then, in step 320, DPS 53 receives a modification 72 from the user 36. In some embodiments, step 320 includes sub-step 322 during logical entity extraction (step 220 from FIG. 3) and sub-step 324 during logical relationship extraction (step 230 from FIG. 3). In step 322, during performance of logical entity extraction, the received modification 72 is an instruction to modify a definition of a logical entity 52. In step 324, during performance of logical relationship extraction, the received modification 72 is an instruction to modify a definition of a logical relationship 57. In other embodiments, step 320 includes sub-step 326, in which the received modification 72 is an instruction to adjust a hyperparameter (not depicted), such that adjusting the hyperparameter would cause a definition of one or more logical entity 52 or logical relationship 57 to change.

Then, in step 330, DPS adjusts the definition of one or more logical entity 52 or logical relationship 57 based on the modification 72. If a hyperparameter is adjusted, then future extraction processes may be improved as well.

In some embodiments, in step 240, mapping module 76 generates a mapping 68 between the entities 52 and elements 67 of a 3D model 66 of the technological system. In some embodiments, step 240 may be implemented in a similar manner as in method 500, described below in connection with FIG. 6.

Then, in step 250, transformation module 59 transforms the set of one or more entities 52 and the set of one or more relationships 57 into a structured file 60 having a hierarchical structure according to a predefined specification (e.g., the UIF schema). In some cases, step 250 further includes sub-step 252, in which transformation module 59 also transforms mapping 68 between the entities 52 and elements 67 of the 3D model 66 into the structured file 60.

In some embodiments (e.g., in embodiments associated with sub-step 216), in step 260, DPS 53 generates a product manual 64 by inputting the structured file 60 into a generative LLM 62, the generative LLM 62 having been trained on a set of other product manuals.

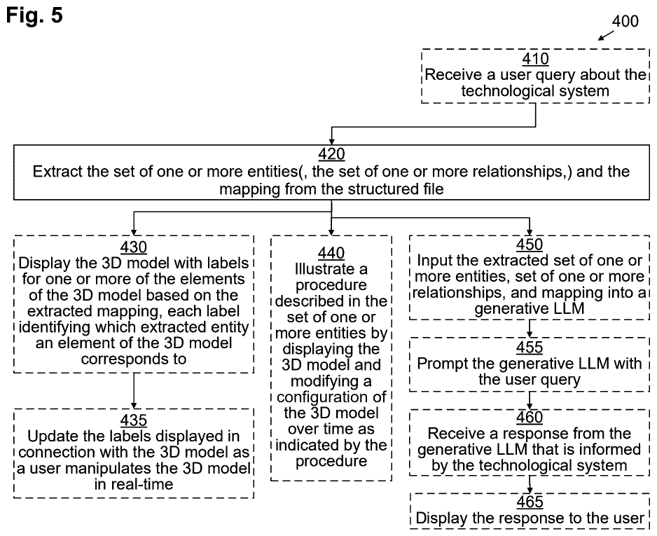

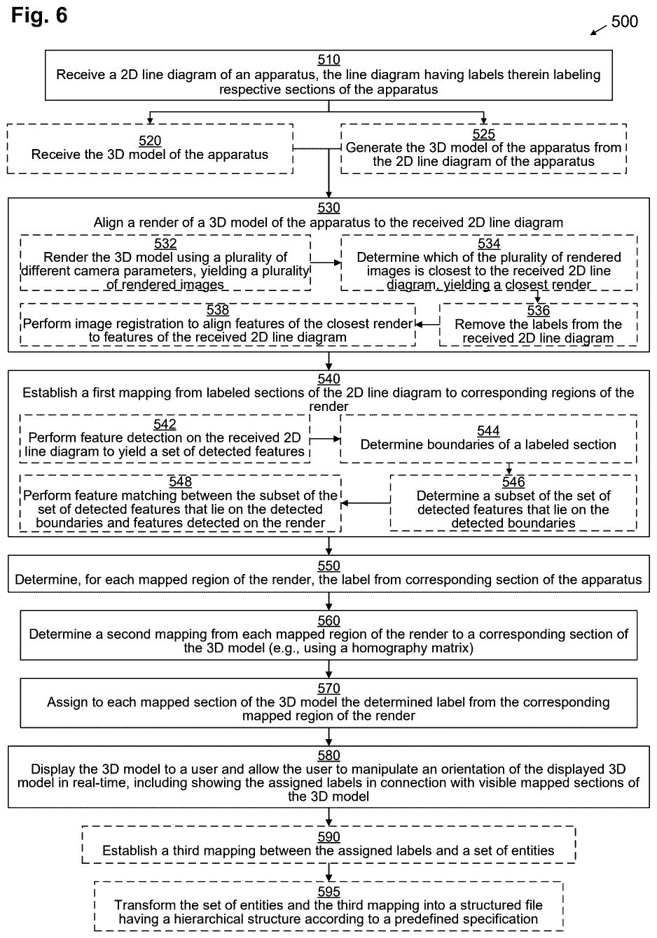

FIG. 5 illustrates an example method 400 performed by computing device 32 of system 100 for making use of the structured file 60. Method 400 may have different realizations, depending on the particular use case. All embodiments of method 400 include step 420, in which extraction module 102 extracts the set of one or more entities 52, the mapping 68, and optionally the set of one or more relationships from the structured file 60.

In some embodiments, step 420 is followed by steps 430 and 435. In step 430, real-time 3D rendering module 106 displays a 3D model 66 with labels 104 for one or more of the elements 67 of the 3D model 66 based on the extracted mapping 68, each rendered label 175 identifying which extracted logical entity 52 an element 67 (rendered as rendered element 167) of the 3D model 66 corresponds to. Then, in step 435, real-time 3D rendering module 106 updates the rendered labels 167 displayed in connection with the rendering 110, 110′ as the user 36 manipulates the 3D model 66 in real-time. Thus, not only does the position of rendered elements 167 corresponding to elements 67 of 3D model 66 change between screenshots 110, 110′ based on the manipulations by the user 36, but the rendered labels 175 are also updated accordingly.

In some embodiments, step 420 is followed by step 440, in which real-time 3D rendering module 106 illustrates a procedure 108 described in one or more of the logical entities 52 or logical relationships 57 by displaying a rendering of a 3D model 66 and modifying a configuration of the 3D model over time as indicated by the procedure 108.

In some embodiments, step 420 is preceded by step 410 and followed by steps 450, 455, 460, 465. In step 410, computing device 32 receives a user query 120 relating to a product.

In step 450, computing device 32 inputs the extracted set of one or more entities 52, the extracted set of or more relationships 57, and the mapping 68 into a generative LLM 162. Then, in step 455, prompt generator 122 generates a prompt and uses it to prompt the generative LLM 162 with the user query 120. In response, in step 460, a response to the user query 120 is received from the generative LLM 162 that is informed by spatial aspects of the product or technological system encoded in the structured file 60. In step 465, the response is displayed to the user 36 on screen 37.

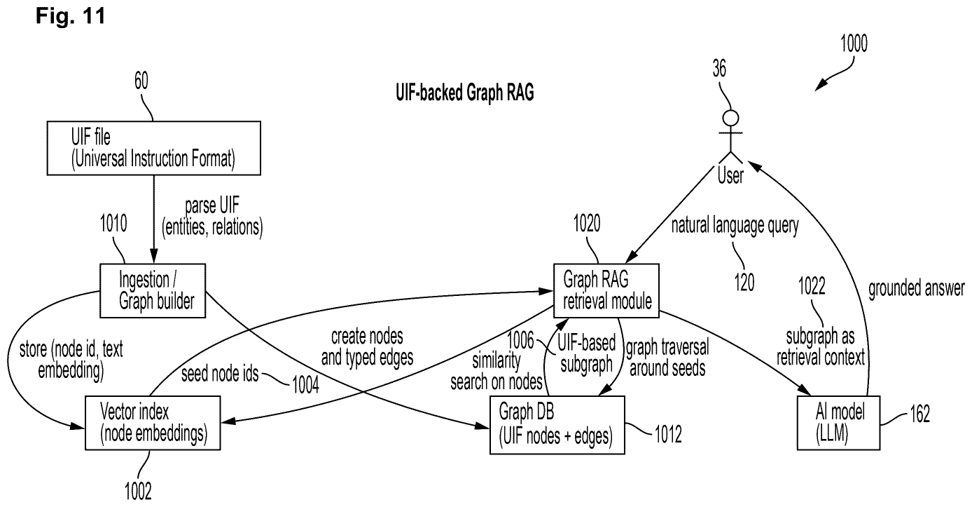

An example embodiment for implementing steps 450-460 using graph-based RAG is illustrated in system 1000 of FIG. 11.

A knowledge graph is stored as nodes (entities 52) and edges (typed relationships 57), and graph-based RAG uses that graph as a structured retrieval layer: a user query 120 is embedded into a vector, a vector index 1002 over node text finds a small set of seed nodes (identified by seed node IDs 1004), and a graph traversal around those seeds (following specific edge types and depths) yields a subgraph 1006 capturing multi-hop, relational context (e.g., components, steps, states, causes). That subgraph 1006 is then serialized (e.g., as structured text, tables, or key—value summaries) and provided as grounding context to the AI model (e.g., generative LLM 162), allowing the model 162 to generate answers that respect the graph's constraints, preserve procedure order, and surface related entities that would not be found by flat vector search alone.

A UIF file 60 serves as the authoritative source for this graph: each UIF element 52 (instruction, step, system, component, state, diagram label, 3D region, root-cause relation, etc.) is ingested (step 1010) as a graph node with properties, and explicit UIF relationships 57 (part-of, next-step, refers-to, located-at, causes, etc.) become typed edges in a graph database 1012; the same UIF-derived nodes are also embedded and stored in a vector index 1002 keyed by node ID. At query time, the Graph RAG module 1020 uses the vector index 1002 to select UIF nodes relevant to the question, expands over the UIF-derived graph to collect connected instructions, components, states, and spatial references, and passes that UIF-based subgraph 1022 to the AI model 162 as its retrieval context-so the model's responses are grounded explicitly in the UIF representation of the system.

FIG. 6 illustrates an example method 500 performed by computing device 32 of system 30, 100 for making use of a 2D line diagram 74 in connection with a 3D model 66 of a technological system or product. Method 400 may have different realizations, depending on the particular use case.

In step 510, DPS 53 receives a 2D line diagram 74 of an apparatus, the 2D line diagram 74 having labels 76 therein labeling respective sections 75 of the apparatus.

In some embodiments, in step 520, DPS 53 receives a 3D model 66 of the apparatus. Alternatively, in other embodiments, in step 525, 3D model 66 is generated from the 2D line diagram 74. In one embodiment, DPS 53 uses photogrammetry techniques and machine learning-based image reconstruction algorithms to convert 2D diagrams and photos into accurate 3D mesh models. It starts by extracting key features from the images, such as edges, contours, and textures, using computer vision techniques. These features are then used to generate a point cloud, which is transformed into a 3D mesh through triangulation and surface fitting algorithms. The system may also incorporate depth estimation and texture mapping to enhance the realism and accuracy of the generated meshes. Post-processing steps, including noise reduction and mesh optimization, ensure that the final 3D models are suitable for immersive applications.

In step 530, mapping module 76 aligns a render 78 of the 3D model 66 to the received 2D line diagram 74. In some embodiments, step 530 may include sub-steps 532-538.

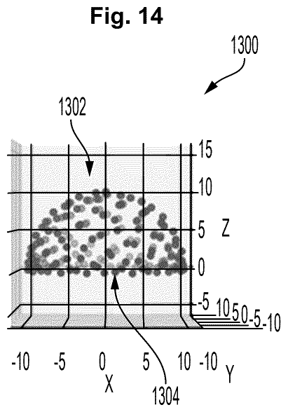

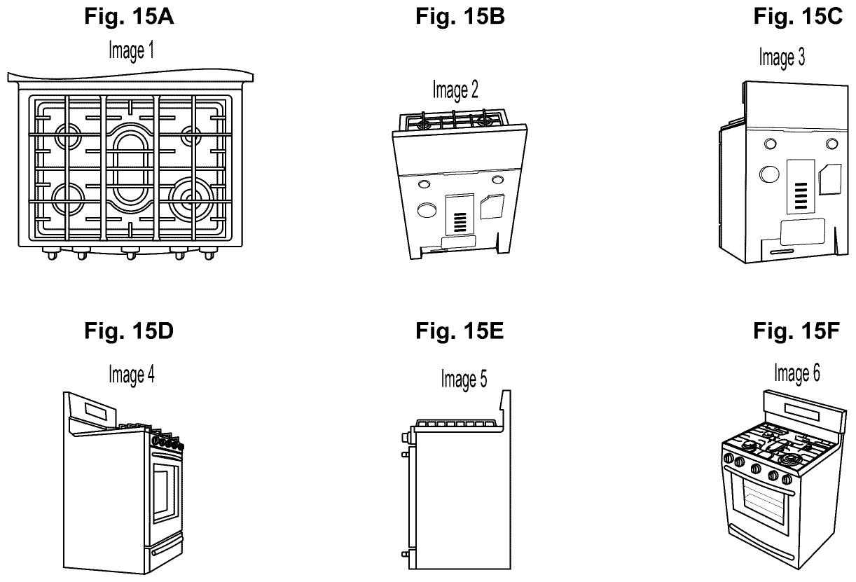

In sub-step 532, computing device 32 renders the 3D model 66 using a plurality of different camera parameters, yielding a plurality of rendered images. For example, several dozen to several hundred different camera positions 1304 may be used spaced evenly about a hemisphere 1302 over the product-see arrangement 1300 of FIG. 14. In addition, for each camera position, several camera directions may be used. In addition, for each camera/direction pair, both an orthographic and perspective projection may be used. FIGS. 15A-15F depict six example renders of 3D model 66 of an oven.

In sub-step 534, computing device 32 determines which of the plurality of rendered images is closest to the received 2D line diagram 1274 from FIG. 13A, yielding a closest 2D render 1278 from FIG. 13B. Sub-step 534 may be accomplished using computer vision to compare the generated images to received 2D line diagram 74. Specifically, techniques such as feature detection (e.g., SIFT, SURF, ORB, AKAZE) and image registration are used to align and match visual elements between the 2D images and the 3D model. Deep learning-based image matching models can also enhance the accuracy of this process by learning complex mappings between 2D and 3D representations. By matching the images, the system is able to determine the orientation of the source image to the 3D model 66.

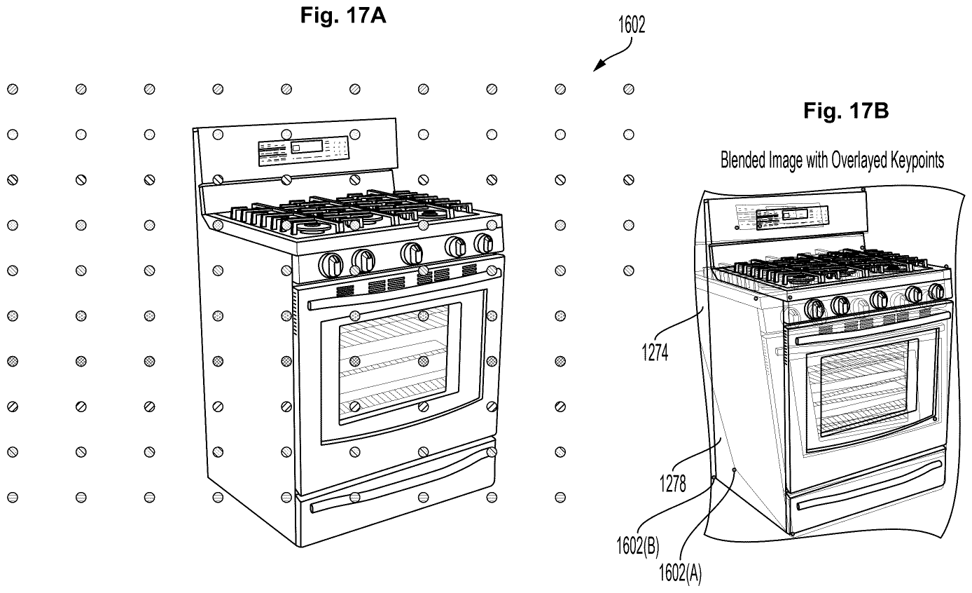

In sub-step 536, computing device 32 locates and removes labels 1276 from the received 2D line diagram 1274 for alignment/registration purposes. Then, in sub-step 538, computing device 32 performs image registration to align features of the closest 2D render 78 to features of the received 2D line diagram 74. For example, with reference to FIG. 17A, keypoints 1602 may be applied, so that when 2D line diagram 1274 and closest 2D render 1278 are overlaid (see FIG. 17B), the keypoints 1602 may be matched up and compared (see keypoint 1602(A) on 2D line diagram 1274 and corresponding keypoint 1602(B) on closest 2D render 1278 in FIG. 17B). Spatial transformations may be applied to accurately map locations on the source image 1274 to corresponding coordinates on the 3D model 66. This involves calculating rotation matrices and translation vectors that align the image features with the 3D geometry, ensuring precise placement and orientation.

In step 540, mapping module 76 establishes a first mapping 80 from labeled sections 75 of the 2D line diagram 74 to corresponding regions 79 of the closest render 78. Thus, for example, the section 1275(3) of the 2D line diagram 1274 of FIG. 13A having a knob labeled “3” is mapped to the region 1379(3) of the closest render 1278 of FIG. 13B having the corresponding knob.

In some embodiments, step 540 may include sub-steps 542-548. In sub-step 542, mapping module 76 performs feature detection on the received 2D line diagram 74 to yield a set of detected features (e.g., edges). In sub-step 544, mapping module 76 determines boundaries of labeled sections 75 of the 2D line diagram 74. In sub-step 546, mapping module 76 determines a subset of the set of detected features that lie on the detected boundaries. In sub-step 548, mapping module 76 performs feature matching between the subset of the set of detected features that lie on the detected boundaries and features detected on the closest 2D render 78.

In step 550, mapping module 76 determines, for each mapped region 79 of the closest 2D render 78, the label 76 from the corresponding section 75 of the apparatus. Labels 76 in documents come in a variety of modes, and recognizing their format is a non-trivial task. Using AI models and computer vision, the system is able to:
Recognize label text in a diagram
Identify indicators (arrows, lines, circles)
Identify indicator target (area, point)
Remove labels from image for better matching to renders (see sub-step 536, above)

Combined with the capabilities of an Entity Relationship Extractor and an Image Spatial Mapper, the system is now able to:
Identify diagrams and labels in a document and identify components of an object referenced in instructions (Entity Relationship Extractor)
Identify and understand labels, label text and legends in a document (Diagram Label Matcher).

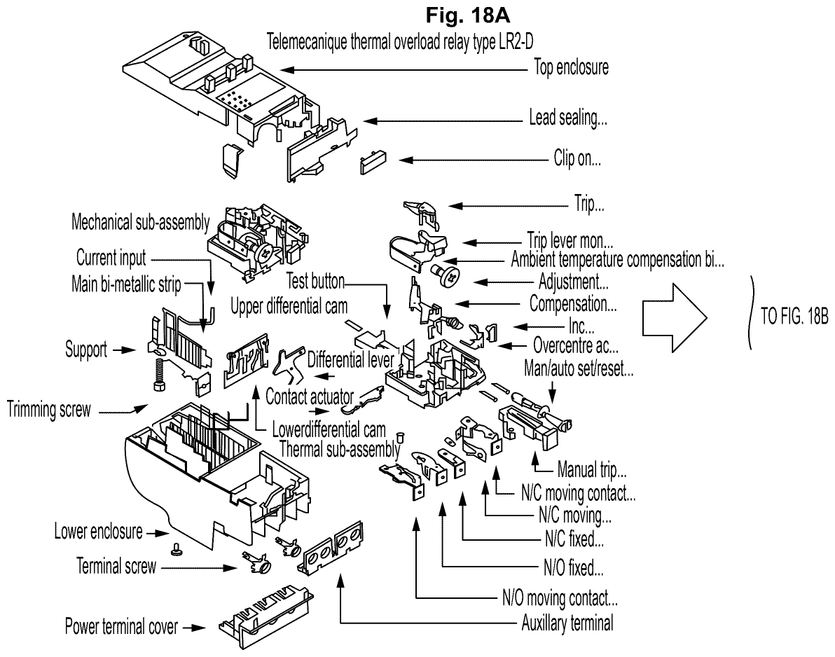

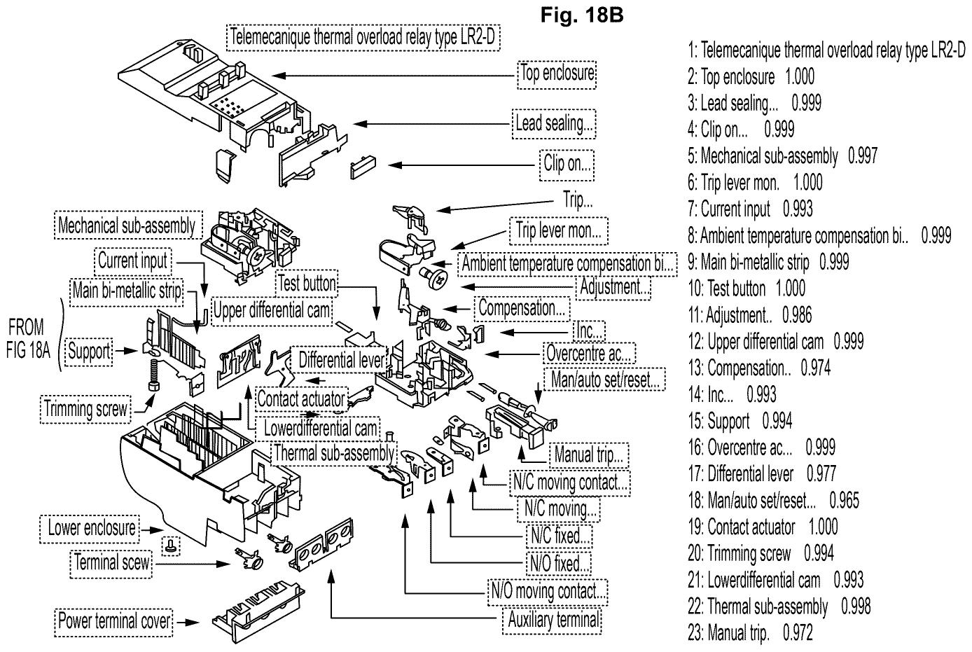

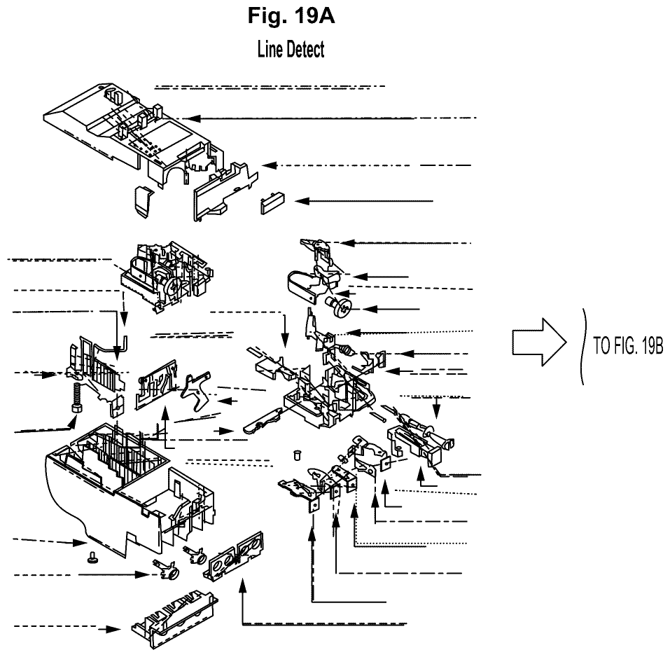

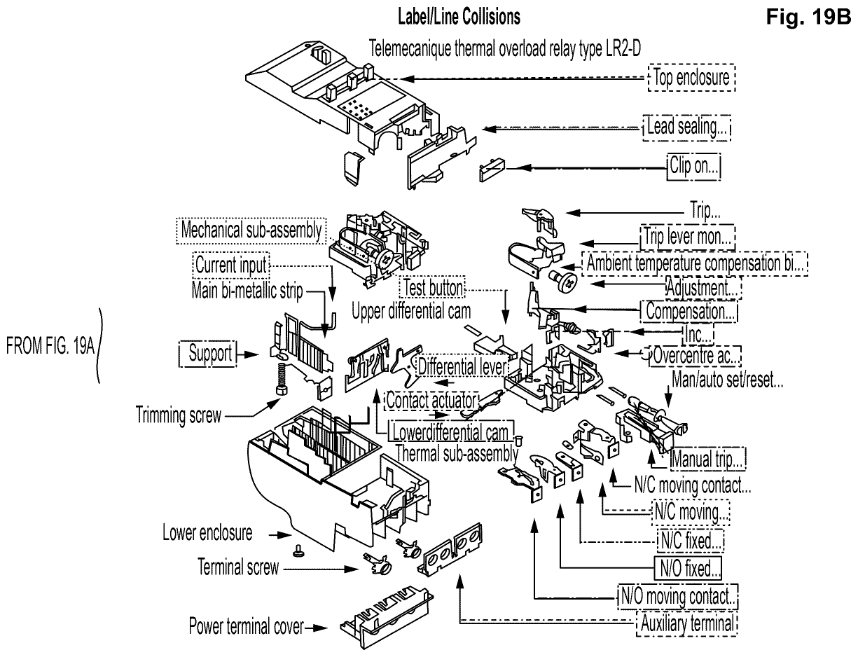

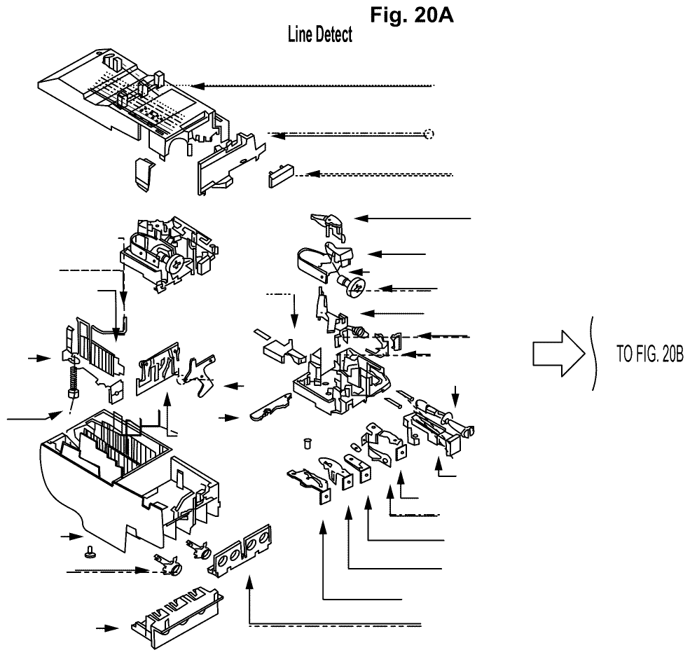

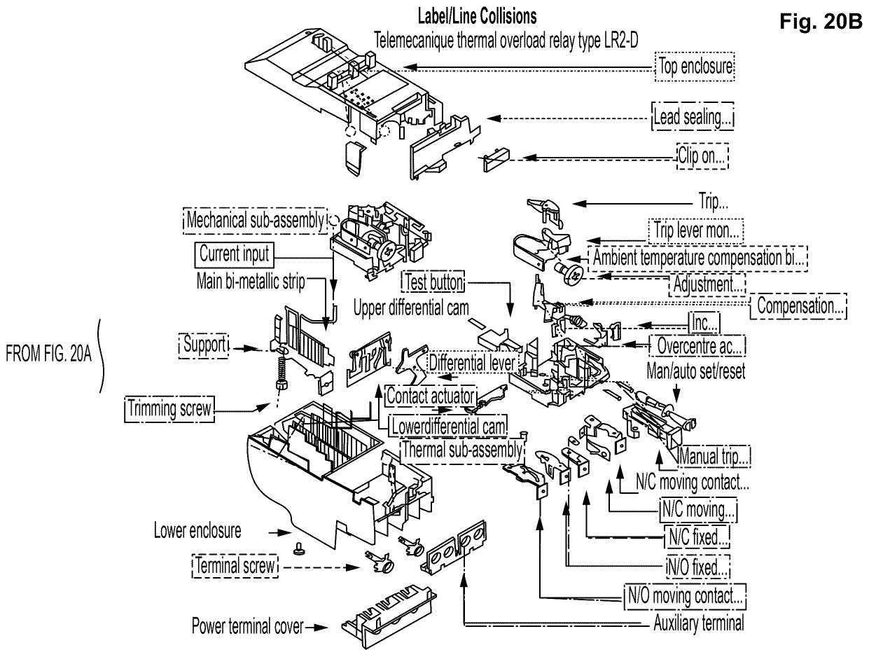

The Diagram Label Matcher employs Optical Character Recognition (OCR) to extract text labels from diagrams, as in FIGS. 18A-B. It then uses pattern recognition and machine learning classifiers to distinguish between different types of indicators and their targets, as in FIGS. 19A-B. For example, arrows might indicate directional flow, while circles could denote specific components. The system also employs image segmentation to isolate labels 76 from the rest of the diagram 74, enabling more accurate matching to the corresponding elements on the 3D model 66, as in FIGS. 20A-B. Furthermore, context-aware algorithms analyze the spatial relationships between labels 76 and their indicators to ensure precise mapping and association within the 3D environment.

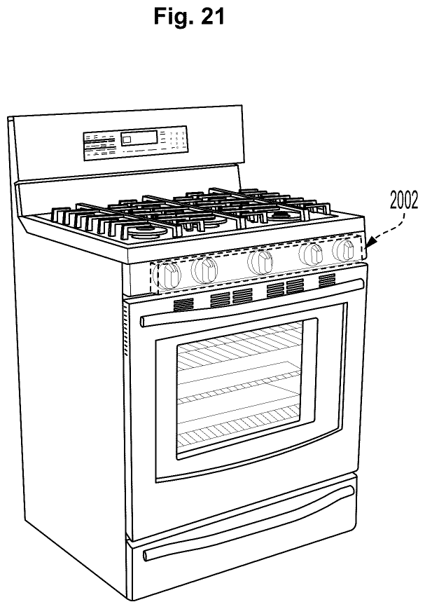

In step 560, mapping module 76 determines a second mapping 82 from each mapped region 79 of the closest 2D render 78 to a corresponding section 67 of the 3D model 66 (e.g., using a homography matrix). See, for example, the boxed region 2002 containing the knobs in FIG. 21.

In step 570, mapping module 76 assigns to each mapped section 67 of the 3D model 66 the determined label 76 from the corresponding mapped region 79 of the closest 2D render 78.

In step 580, 3D rendering module 106 displays the 3D model 66 to the user 36 and allows the user 36 to manipulate an orientation of the displayed 3D model 66 in real-time (see screenshots 110, 110′ of FIG. 2), including showing the assigned labels 175 in connection with visible mapped sections 167 of the 3D model 66.

In some embodiments, in step 590, mapping module 76 establishes a third mapping 68 between the assigned labels 76 of elements of 3D model 66 and the set of logical entities 52.

In some embodiments, in step 595, mapping module 76 transforms the set of entities 52 and the third mapping 68 into a structured file 60 having a hierarchical structure according to a predefined specification (e.g., a UIF file).

### 4. Example

### Example Technique

### Brief: Scaling Maintenance Training to XR

### Overview of the Situation

A manufacturing facility specializing in high-volume material handling systems, such as industrial conveyor systems, faces significant operational challenges. The current maintenance and calibration processes for these systems are only documented in legacy paper manuals and training videos. This reliance on outdated methods creates bottlenecks in knowledge transfer and increases the risk of errors during critical maintenance tasks.

### Facility Description

Type: Medium-scale manufacturing plant focused on automated material handling.
Key Equipment: Conveyor systems for transporting raw materials and finished goods.
Staff:
   Experienced technicians nearing retirement.
   Newly hired operators unfamiliar with the equipment.
Training Environment:
   No centralized training program.
   Heavy reliance on senior technicians for on-the-job mentoring.
   Training sessions use static reference materials and fragmented video tutorials.
      Challenges with the Current System
1. Knowledge Silos:
   Processes and expertise primarily reside in the heads of senior technicians.
   Documentation is fragmented across outdated manuals and poorly cataloged training videos.
2. Inconsistent Training:
   Lack of standardization in how tasks are taught to new hires.
   Training quality depends on the availability of experienced staff.
3. Error-Prone Processes:
   Legacy manuals fail to provide context-sensitive guidance, leading to frequent errors.
   Troubleshooting tasks require technicians to cross-reference static guides and videos.
4. Inefficiency:
   High downtime during maintenance due to the manual nature of troubleshooting and calibration.
   Time-consuming training sessions that take technicians away from critical operations.

### Why Scale to XR-Based Training?

1. Contextual Guidance:
   XR platforms can overlay interactive instructions directly onto physical equipment, eliminating the need for cross-referencing.
2. Standardized Knowledge Transfer:
   XR allows training content to be standardized and consistent across all users, regardless of their skill level.
3. Enhanced Learning:
   Immersive VR training modules can provide hands-on experience without requiring access to physical equipment.
   Gamified learning improves retention compared to static manuals.
4. Real-time Assistance:
   AR applications can provide real-time feedback, such as flagging incorrect alignment or improper tension adjustments.
5. Scalability:
   Once developed, XR modules can be deployed to multiple facilities with minimal additional cost.

### Objective

To transition from legacy manuals and training videos to a Universal Instruction Format (UIF) as the foundation for developing XR training applications. By first digitizing the existing processes into UIF, we can standardize the knowledge base, reduce reliance on senior technicians, and scale the solution to immersive XR platforms for efficient training and real-time task guidance.

### Scenario: Basic Conveyor Belt Maintenance and Calibration

### User Manual 60 Documents:

1. System Description—Details of the conveyor system and its components.
2. Maintenance Workflow—Step-by-step instructions for checking, cleaning, and calibrating the conveyor.
3. Troubleshooting Guide—Common issues and how to resolve them.
4. Safety Precautions—Standard safety measures.

The manual uses clear, static instructions and images (or placeholders) to simulate an easy-to-understand reference. An example manual 60 is depicted on the next 4 pages:

### Mock Manual: Basic Conveyor Belt Maintenance

### Page 1: System Overview

### Title: Conveyor System Basics

Purpose: The conveyor system transports materials efficiently in manufacturing and warehousing environments.

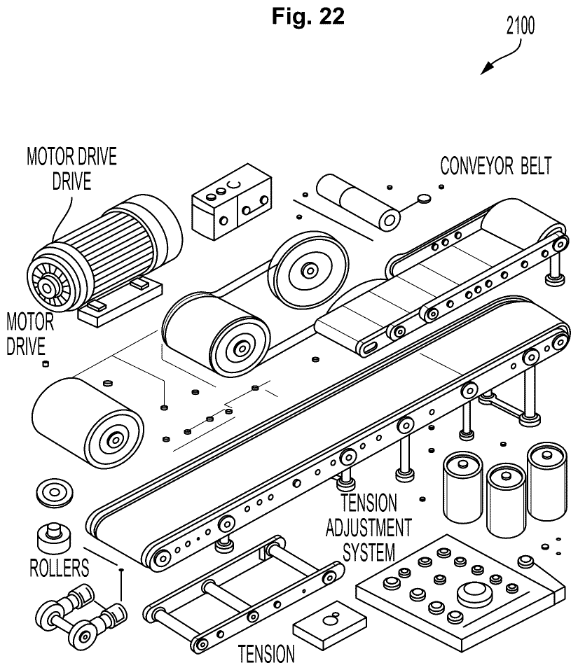

Components: [FIG. 22 embedded here]
1. Motor Drive: Powers the conveyor belt.
2. Conveyor Belt: Carries items along the system.
3. Rollers: Maintain belt alignment and support.
4. Tension Adjustment System: Ensures proper belt tension.
5. Control Panel: Operates the conveyor.

### Operation Cycle:

1. Start the system via the control panel.
2. Monitor belt movement for smooth operation.
3. Stop the system after use.

### Page 2: Routine Maintenance Workflow

### Title: Weekly Maintenance Procedure

### 1. Turn Off Power

Ensure the system is powered down.
Lockout/tagout the control panel.

### 2. Inspect the Belt

Look for signs of wear or damage.
Verify the belt is aligned with the rollers.

### 3. Clean the System.

Use a dry cloth to wipe the belt and rollers.
Remove any debris caught in the system.

### 4. Check Belt Tension

Locate the tension adjustment system.
Measure tension using a tension gauge.
Adjust the tension if it falls outside the specified range (e.g., 50-60 N).

### 5. Lubricate Moving Parts

Apply lubricant to rollers and joints as per manufacturer guidelines.

### Page 3: Troubleshooting Guide

### Title: Resolving Common Conveyor Issues

### Issue 1: Belt Misalignment.

Symptom: The belt veers off-center during operation.
Steps to Resolve:
   1. Stop the system and inspect roller alignment.
   2. Adjust the tension adjustment system to correct alignment.
   3. Test-run the system to ensure alignment.

### Issue 2: Conveyor Doesn't Start.

Symptom: No movement when the system is powered on.
Steps to Resolve:
   1. Check the control panel for active power supply.
   2. Inspect the motor drive for signs of failure.
   3. Confirm no obstructions are blocking the belt.

### Issue 3: Unusual Noise

Symptom: Loud grinding or squeaking noise during operation.
Steps to Resolve:
   1. Stop the system immediately.
   2. Inspect the rollers for debris or wear.
   3. Lubricate moving parts if necessary.

### Page 4: Safety Precautions

### Title: Conveyor Maintenance Safety Checklist

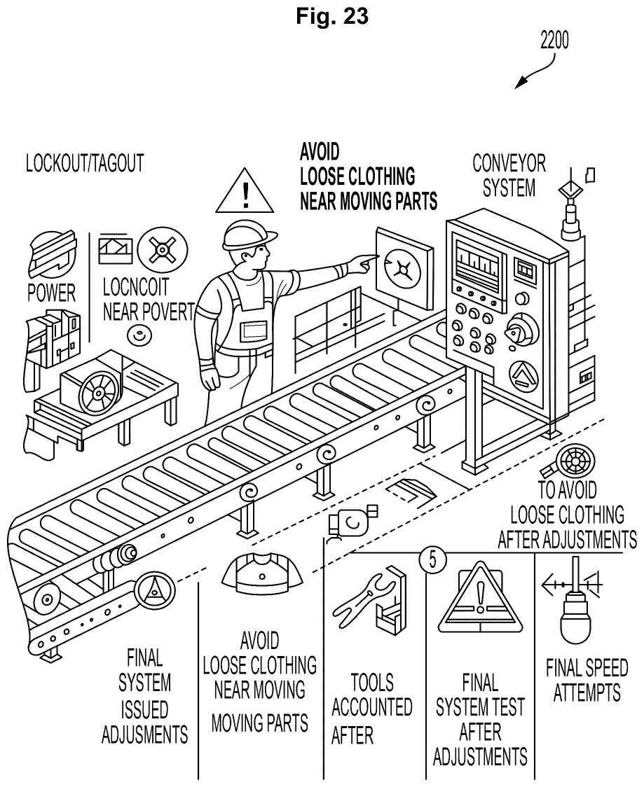

### [FIG. 23 Embedded Here]

### 1. Before Maintenance:

Always disconnect the power.
Use lockout/tagout procedures.
Wear appropriate PPE (gloves, safety glasses).

### 2. During Maintenance:

Avoid loose clothing near moving parts.
Ensure tools are accounted for after adjustments.

### 3. Post-Maintenance:

Conduct a full system test before resuming operation.
Document all maintenance actions.

### Document Processing Service Export

After providing the printed manual 60 and associated CAD models to the Document Processing Service, the following steps occur:
1. Ingestion:
   The service ingests static documents and spatial models.
2. Entity Extraction:
   Natural Language Processing (NLP) algorithms extract logical entities such as components, processes, tasks, and instructions from the text.
3. Image-to-Spatial Mapping:
   Images and diagrams from the manual are mapped to corresponding spatial coordinates in the CAD models using computer vision techniques.
4. Human-in-the-Loop Review:
   Technicians review and, if necessary, override automated decisions to ensure accuracy and compliance with safety standards.
5. Conversion to UIF Package:
   The extracted and mapped data are structured into the UIF package (see code listing in Computer Program Listing Appendix B), incorporating spatial, temporal, and logical relationships.
      Transformation into XR Applications

Using the UIF package, developers create XR applications that provide:
Interactive Training Modules (VR):
   Technicians engage in virtual simulations replicating the conveyor system.
   The VR environment includes interactive elements and immediate feedback mechanisms.
Real-time AR Guidance:
   AR applications overlay step-by-step instructions onto the physical equipment during actual maintenance tasks.
   Real-time sensors provide feedback, such as highlighting components needing attention.

### User Experience in XR Applications

VR Training:
   Upon entering the VR module, technicians are guided through maintenance procedures with interactive prompts.
   The system adjusts the difficulty based on the technician's performance, providing a personalized learning path.
AR Assistance:
   Technicians use AR glasses to view overlayed instructions directly on the equipment.
   The application provides real-time alerts if safety protocols are not followed.

### Integration of AI/ML Models

Predictive Maintenance:
   AI models analyze telemetry data to predict potential equipment failures.
   Technicians receive proactive alerts during XR sessions about components that may require attention.
Adaptive Learning Paths:
   Machine Learning algorithms adjust training content based on individual performance metrics.
Explainability:
   The system uses SHAP (SHapley Additive explanations) to provide transparent reasoning behind AI-driven recommendations.

### Benefits Realized.

Reduced Training Time:
   Training duration decreased by 40% compared to traditional methods.
Improved Knowledge Retention:
   Technicians demonstrate a 30% improvement in retention rates.
Decreased Downtime:
   Maintenance errors reduced by 25%, leading to less operational downtime.
Scalability:
   XR modules deployed across multiple facilities with minimal additional development costs.

### Safety and Compliance

Regulatory Adherence:
   The XR applications are designed in compliance with industry safety regulations, such as OSHA standards.
Safety Features in XR:
   Virtual barriers and alerts prevent unsafe actions during training and real-world applications.
   The system enforces lockout/tagout procedures through mandatory steps in the XR application.

### Feedback Loop and Continuous Improvement.

Data Collection:
   User interactions, performance metrics, and telemetry data are collected during XR sessions.
UIF Package Updates:
   The Document Processing Service uses collected data to update the UIF package, ensuring content remains relevant and effective.
Model Retraining:

AI/ML models are retrained based on new data, improving predictive accuracy and personalization over time.

### 5. Conclusion

While various embodiments of the invention have been particularly shown and described, it will be understood by those skilled in the art that various changes in form and details may be made therein without departing from the spirit and scope of the invention as defined by the appended claims.

It should be understood that although various embodiments have been described as being methods, software embodying these methods is also included. Thus, one embodiment includes a tangible computer-readable medium (such as, for example, a hard disk, a floppy disk, an optical disk, computer memory, flash memory, etc.) programmed with instructions, which, when performed by a computer or a set of computers, cause one or more of the methods described in various embodiments to be performed. Another embodiment includes a computer which is programmed to perform one or more of the methods described in various embodiments.

Furthermore, it should be understood that all embodiments which have been described may be combined in all possible combinations with each other, except to the extent that such combinations have been explicitly excluded.

Finally, nothing in this Specification shall be construed as an admission of any sort. Even if a technique, method, apparatus, or other concept is specifically labeled as “background” or as “conventional,” Applicant makes no admission that such technique, method, apparatus, or other concept is actually prior art under relevant law, such determination being a legal determination that depends upon many factors, not all of which are known to Applicant at this time.

What is claimed is:

1. A method, performed by a computer system, the method comprising:
receiving a 2-dimensional line diagram of an apparatus, the line diagram having labels therein labeling respective sections of the apparatus;
aligning a render of a 3-dimensional model of the apparatus to the received 2-dimensional line diagram;
establishing a first mapping from labeled sections of the 2-dimensional line diagram to corresponding regions of the render;
determining, for each mapped region of the render, the label from the corresponding section of the apparatus;
determining a second mapping from each mapped region of the render to a corresponding section of the 3-dimensional model;
assigning to each mapped section of the 3-dimensional model the determined label from the corresponding mapped region of the render; and
displaying the 3-dimensional model to a user and allowing the user to manipulate an orientation of the displayed 3-dimensional model in real-time, wherein displaying includes showing the assigned labels in connection with visible mapped sections of the 3-dimensional model.

2. The method of claim 1 wherein the method further comprises receiving the 3-dimensional model of the apparatus.

3. The method of claim 1 wherein the method further comprises generating the 3-dimensional model of the apparatus from the 2-dimensional line diagram of the apparatus.

4. The method of claim 1 wherein aligning the render of the 3-dimensional model of the apparatus to the received 2-dimensional line diagram includes:
rendering the 3-dimensional model using a plurality of different camera parameters, yielding a plurality of rendered images;
determining which of the plurality of rendered images is closest to the received 2-dimensional line diagram, yielding a closest render; and
performing image registration to align features of the closest render to features of the received 2-dimensional line diagram.

5. The method of claim 4 wherein aligning the render of the 3-dimensional model of the apparatus to the received 2-dimensional line diagram further includes removing the labels from the received 2-dimensional line diagram.

6. The method of claim 1 wherein establishing the first mapping includes:
performing feature detection on the received 2-dimensional line diagram to yield a set of detected features;
determining boundaries of a labeled section;
determining a subset of the set of detected features that lie on the detected boundaries; and
performing feature matching between the subset of the set of detected features that lie on the detected boundaries and features detected on the render.

7. The method of claim 1 wherein determining the second mapping includes using a homography matrix.

8. The method of claim 1 wherein the method further comprises:
establishing a third mapping between the assigned labels and a set of entities; and
transforming the set of entities and the third mapping into a structured file having a hierarchical structure according to a predefined specification.

9. A computer program product comprising a non-transitory computer-readable storage medium storing instructions, which, when performed by processing circuitry of a computer system, cause the computer system to:
receive a 2-dimensional line diagram of an apparatus, the line diagram having labels therein labeling respective sections of the apparatus;
align a render of a 3-dimensional model of the apparatus to the received 2-dimensional line diagram;
establish a first mapping from labeled sections of the 2-dimensional line diagram to corresponding regions of the render;
determine, for each mapped region of the render, the label from the corresponding section of the apparatus;
determine a second mapping from each mapped region of the render to a corresponding section of the 3-dimensional model;
assign to each mapped section of the 3-dimensional model the determined label from the corresponding mapped region of the render; and
display the 3-dimensional model to a user and allow the user to manipulate an orientation of the displayed 3-dimensional model in real-time, wherein displaying includes showing the assigned labels in connection with visible mapped sections of the 3-dimensional model.

10. The computer program product of claim 9 wherein the instructions, when performed by the processing circuitry, further cause the computer system to receive the 3-dimensional model of the apparatus.

11. The computer program product of claim 9 wherein the instructions, when performed by the processing circuitry, further cause the computer system to generate the 3-dimensional model of the apparatus from the 2-dimensional line diagram of the apparatus.

12. The computer program product of claim 9 wherein aligning the render of the 3-dimensional model of the apparatus to the received 2-dimensional line diagram includes:
rendering the 3-dimensional model using a plurality of different camera parameters, yielding a plurality of rendered images;
determining which of the plurality of rendered images is closest to the received 2-dimensional line diagram, yielding a closest render; and
performing image registration to align features of the closest render to features of the received 2-dimensional line diagram.

13. The computer program product of claim 12 wherein aligning the render of the 3-dimensional model of the apparatus to the received 2-dimensional line diagram further includes removing the labels from the received 2-dimensional line diagram.

14. The computer program product of claim 9 wherein establishing the first mapping includes:
performing feature detection on the received 2-dimensional line diagram to yield a set of detected features;
determining boundaries of a labeled section;
determining a subset of the set of detected features that lie on the detected boundaries; and
performing feature matching between the subset of the set of detected features that lie on the detected boundaries and features detected on the render.

15. The computer program product of claim 9 wherein determining the second mapping includes using a homography matrix.

16. The computer program product of claim 9 wherein the instructions, when performed by the processing circuitry, further cause the computer system to:
establish a third mapping between the assigned labels and a set of entities; and
transform the set of entities and the third mapping into a structured file having a hierarchical structure according to a predefined specification.

17. A computer system comprising:
user interface circuitry configured to display images to a display screen; and
processing circuitry coupled with memory, configured to:
receive a 2-dimensional line diagram of an apparatus, the line diagram having labels therein labeling respective sections of the apparatus;
align a render of a 3-dimensional model of the apparatus to the received 2-dimensional line diagram;
establish a first mapping from labeled sections of the 2-dimensional line diagram to corresponding regions of the render;
determine, for each mapped region of the render, the label from the corresponding section of the apparatus;
determine a second mapping from each mapped region of the render to a corresponding section of the 3-dimensional model;
assign to each mapped section of the 3-dimensional model the determined label from the corresponding mapped region of the render; and
display, via the user interface circuitry, the 3-dimensional model to a user and allow the user to manipulate an orientation of the displayed 3-dimensional model in real-time, wherein displaying includes showing the assigned labels in connection with visible mapped sections of the 3-dimensional model.

18. The computer system of claim 17 wherein the processing circuitry coupled with memory is further configured to receive the 3-dimensional model of the apparatus.

19. The computer system of claim 17 wherein the processing circuitry coupled with memory is further configured to generate the 3-dimensional model of the apparatus from the 2-dimensional line diagram of the apparatus.

20. The computer system of claim 17 wherein aligning the render of the 3-dimensional model of the apparatus to the received 2-dimensional line diagram includes:
rendering the 3-dimensional model using a plurality of different camera parameters, yielding a plurality of rendered images;
determining which of the plurality of rendered images is closest to the received 2-dimensional line diagram, yielding a closest render; and
performing image registration to align features of the closest render to features of the received 2-dimensional line diagram.
